(19) United States
(12) Patent Application Publication
(10) Pub. No.: US 2026/0187191 A1
(43) Pub. Date: Jul. 2, 2026

(54) DATA QUALITY ESTIMATION USING MACHINE LEARNING MODEL

(71) Applicant: International Business Machines Corporation, Armonk, NY (US)

(72) Inventors: Jonathan David Dunne, Dungarvan (IE); Krishna Manish Sheth, Lowell, MA (US); Andrew Thomas Penrose, Castleknock (IE)

(21) Appl. No.: 19/001,966

(22) Filed: Dec. 26, 2024

(51) Int. Cl. G06F 17/18

(52) U.S. Cl. CPC G06F 17/18

(57) ABSTRACT

Data quality estimation using machine learning (ML) model is provided and includes receiving an input dataset having one or more heterogeneous datasets from one or more data sources. Each heterogeneous dataset of the one or more heterogeneous datasets includes one or more data items. An attention-based ML model is applied to the input dataset and one or more first probability scores associated with the one or more heterogeneous datasets are calculated based on the application. Further, one or more encoding matrices associated with the one or more heterogeneous datasets are determined based on the one or more first probability scores and a probabilistic technique is applied to the one or more encoding matrices. Further, a quality score associated with the input dataset is determined based on the application of the probabilistic technique and the determined quality score is outputted.

### BACKGROUND

The disclosure relates to data quality estimation techniques and more particularly, to data quality estimation using a machine learning (ML) model.

Data quality estimation refers to the process of evaluating data based on various criteria such as accuracy, completeness, consistency, reliability, and relevance. This estimation involves identifying data issues, measuring the extent of these issues, and determining their impact on business processes and decision-making. The application areas of data quality estimation are vast and varied. For example, in the field of healthcare, data quality estimation is used to ensure that patient records are accurate and up to date, which is crucial for patient safety. In the field of finance, data quality estimation helps in maintaining accurate transaction records and compliance with regulatory standards. In the field of marketing, data quality ensures customer data is reliable, enabling targeted and effective campaigns. Additionally, in the field of supply chain management, data quality estimation is used to ensure that inventory data is accurate, which is critical for efficient logistics and inventory control. Hence, it can be said that every industry that relies on data for decision-making can benefit from data quality estimation.

The advantages of data quality estimation include improved decision-making, increased operational efficiency, and enhanced customer satisfaction. By identifying and rectifying data issues, organizations can make more accurate and timely decisions. Furthermore, reliable data leads to better strategic planning and competitive advantage. Additionally, high-quality data reduces the time and resources spent on pre-processing operations (such as data cleaning and data correction), thereby increasing productivity. Also, reliable data enhances customer trust and satisfaction, as interactions and services are based on accurate information. Therefore, data quality estimation is a critical process as data plays a critical role in modern organizations.

### SUMMARY

According to an embodiment of the disclosure, a computer-implemented method for data quality estimation using machine learning (ML) model is described. The computer-implemented method includes receiving, by a computer, an input dataset including one or more heterogeneous datasets from one or more data sources. Each heterogeneous dataset of the one or more heterogeneous datasets includes one or more data items. The computer-implemented method further includes applying, by the computer, an attention-based machine learning (ML) model to the input dataset. The computer-implemented method further includes calculating, by the computer, one or more first probability scores associated with the one or more heterogeneous datasets based on the application of the attention-based ML model to the input dataset. Each first probability score of the one or more first probability scores is associated with the one or more data items of a respective heterogeneous dataset of the one or more heterogeneous datasets. The computer-implemented method further includes determining, by the computer, one or more encoding matrices associated with the one or more heterogeneous datasets based on the one or more first probability scores associated with the one or more heterogeneous datasets. The computer-implemented method further includes applying, by the computer, a probabilistic operation on the one or more encoding matrices associated with the one or more heterogeneous datasets. The computer-implemented method further includes determining, by the computer, a quality score associated with the input dataset based on the application of the probabilistic operation on the one or more encoding matrices associated with the one or more heterogeneous datasets. The computer-implemented method further includes outputting, by the computer, the determined quality score.

According to one or more embodiments of the disclosure, a computer system for data quality estimation using machine learning (ML) model is described. The computer system includes a processor set, one or more computer-readable storage media, and program instructions stored on the one or more computer-readable storage media. The program instructions are executable by the processor set and cause the processor set to receive an input dataset that includes one or more heterogeneous datasets from one or more data sources. Each heterogeneous dataset of the one or more heterogeneous datasets includes one or more data items. The program instructions further cause the processor set to apply an attention-based machine learning (ML) model to the input dataset. The program instructions further cause the processor set to calculate one or more first probability scores associated with the one or more heterogeneous datasets based on the application of the attention-based ML model to the input dataset. Each first probability score of the one or more first probability scores is associated with the one or more data items of a respective heterogeneous dataset of the one or more heterogeneous datasets. The program instructions further cause the processor set to determine one or more encoding matrices associated with the one or more heterogeneous datasets based on the one or more first probability scores associated with the one or more heterogeneous datasets. The program instructions further cause the processor set to apply a probabilistic operation on the one or more encoding matrices associated with the one or more heterogeneous datasets. The program instructions further cause the processor set to determine a quality score associated with the input dataset based on the application of the probabilistic operation on the one or more encoding matrices associated with the one or more heterogeneous datasets. The program instructions further cause the processor set to output the determined quality score.

According to one or more embodiments of the disclosure, a computer program product for data quality estimation using machine learning (ML) model is described. The computer program product includes one or more computer-readable storage media and program instructions stored in the one or more computer-readable storage media to perform operations that include receiving an input dataset that includes one or more heterogeneous datasets from one or more data sources. Each heterogeneous dataset of the one or more heterogeneous datasets includes one or more data items. The operations further include applying an attention-based machine learning (ML) model to the input dataset. The operations further include calculating one or more first probability scores associated with the one or more heterogeneous datasets based on the application of the attention-based ML model to the input dataset. Each first probability score of the one or more first probability scores is associated with the one or more data items of a respective heterogeneous dataset of the one or more heterogeneous datasets. The operations further include determining one or more encoding matrices associated with the one or more heterogeneous datasets based on the one or more first probability scores associated with the one or more heterogeneous datasets. The operations further include applying a probabilistic operation on the one or more encoding matrices associated with the one or more heterogeneous datasets. The operations further include determining a quality score associated with the input dataset based on the application of the probabilistic operation on the one or more encoding matrices associated with the one or more heterogeneous datasets. The operations further include outputting the determined quality score.

Additional technical features and benefits are realized through the techniques of the disclosure. Embodiments and aspects of the disclosure are described in detail herein and are considered a part of the claimed subject matter. For a better understanding, refer to the detailed description and the drawings.

### BRIEF DESCRIPTION OF THE DRAWINGS

The following description will provide details of preferred embodiments with reference to the following figures wherein:

FIG. 1 is a diagram that illustrates a computing environment for data quality estimation using machine learning (ML) model, in accordance with an embodiment of the disclosure;

FIG. 2 is a diagram that illustrates an environment for data quality estimation using machine learning (ML) model, in accordance with an embodiment of the disclosure;

FIG. 3 is a diagram that illustrates exemplary operations for data quality estimation using machine learning (ML) model, in accordance with an embodiment of the disclosure;

FIG. 4 is a diagram that illustrates an exemplary beta probability density distribution graph for data quality estimation using machine learning (ML) model, in accordance with an embodiment of the disclosure;

FIG. 5 is a diagram that illustrates exemplary operations for training a machine learning (ML) model using data quality estimation, in accordance with an embodiment of the disclosure;

FIG. 6A is a diagram that illustrates an exemplary first user interface for data quality estimation using machine learning (ML) models, in accordance with an embodiment of the disclosure;

FIG. 6B is a diagram that illustrates an exemplary second user interface for data quality estimation using machine learning (ML) models, in accordance with an embodiment of the disclosure; and

FIG. 7 is a diagram that illustrates a flowchart of an exemplary method for data quality estimation using machine learning (ML) model, in accordance with an embodiment of the disclosure.

### DETAILED DESCRIPTION

Data quality estimation is a crucial process for modern organizations because data plays a critical role. High-quality data is crucial for informed decision-making, operational optimization, and regulatory compliance, while low-quality data often leads to inaccurate conclusions, inefficiencies, reputational damage, and increased expenses. For example, incorrect customer data can result in ineffective marketing campaigns, and incomplete financial data can lead to inaccurate financial reporting. Hence, it is vital to estimate and enhance data quality to uphold the integrity and efficiency of business operations.

Data quality estimation refers to the process of evaluating data based on various criteria such as accuracy, completeness, consistency, reliability, and relevance. This estimation involves identifying data issues, measuring the extent of these issues, and determining their impact on business processes and decision-making. By systematically examining data quality, organizations ensure that their data assets are fit for purpose and can be trusted for analysis and reporting.

The application areas of data quality estimation are diverse. For example, in healthcare, data quality estimation is critical to verify the accuracy of patient records to ensure patient safety and effective treatment. In finance, data quality estimation aids in maintaining precise transaction records. Furthermore, in supply chain management, data quality estimation is crucial to ensure the accuracy of inventory data for efficient logistics and inventory control. Therefore, this can be concluded that data quality estimation is beneficial for decision-making in any industry reliant on data.

The advantages of data quality estimation include improved decision-making, increased operational efficiency, and enhanced customer satisfaction. By identifying and rectifying data issues, organizations can make more accurate and timely decisions. Furthermore, it leads to better strategic planning and competitive advantage. Additionally, high-quality data reduces the time and resources spent on pre-processing operations (such as data cleaning and data correction), thereby increasing productivity. Also, reliable data enhances customer trust and satisfaction, as interactions and services are based on accurate information.

As of now, several problems are present in current data quality estimation techniques and the same are challenging to address. One major issue of data quality estimation is the sheer amount of data in modern organizations. With data coming from multiple sources and in various formats, ensuring consistency and accuracy can be cumbersome, difficult, and daunting. Additionally, data quality issues often go unnoticed until they cause significant problems, making proactive estimation and correction difficult. An additional challenge is the lack of standardized metrics and methodologies for assessing data quality, which can lead to inconsistent and unreliable estimations.

Moreover, data quality estimation can be resource-intensive, requiring significant time, effort, and expertise. Specifically, organizations struggle with the cost of implementing comprehensive data quality programs, especially if they lack the required tools and technologies. Therefore, maintaining data quality is an ongoing process, requiring continuous monitoring and improvement, which can be challenging to sustain over time.

Existing methods of data quality estimation often face significant challenges when applied across different domains. In academic literature, data quality and reliability are frequently associated with medical data sources, leading to the use of classical statistical techniques tailored to this field of medical data. However, these classical statistical techniques are domain-specific and may not be effective when applied to industries, such as finance or marketing. The primary issue is that these techniques are designed to address specific problems within a particular domain, making it difficult to generalize their application to other fields. This lack of cross-domain applicability limits the effectiveness of these methods in providing a comprehensive solution to data quality issues.

A major problem with existing data quality estimation techniques is their inability to handle different types of data uniformly. Many techniques are developed with a focus on a specific type of data, such as categorical data, and may not perform well when applied to data types like discrete data, continuous data, or ordinal data. This limitation arises because the rules and inferences used in these methods are often tailored to the characteristics of a particular data type. As a result, when these methods are applied to different data types, they may fail to accurately estimate and address data quality issues, leading to incomplete or biased results.

While basic data quality issues can be effectively addressed using existing techniques, there are additional concerns that these methods fail to resolve. For instance, imputation techniques can fill in missing values, but they may not address underlying issues such as data inconsistency, redundancy, or inaccuracies that arise from data integration processes. These more complex data quality problems require advanced solutions that go beyond simple imputation. To address these challenges, there is a need to develop a domain-independent and data-type-independent data quality estimation method that can provide a comprehensive framework for assessing and improving data quality across various domains and data types.

The disclosed system performs data quality estimation using a machine learning (ML) model. The disclosed system addresses additional data quality issues such as data inconsistency, data redundancy, and data inaccuracies present in the data. The disclosed system provides a domain-independent way for estimation of data quality cross-domains to solve the problem associated with the existing methods. Therefore, the disclosed system can be used to perform data quality estimation accurately across various industries like finance, healthcare, marketing, and the like without the need for tailored approaches specific to these domains. The disclosed system further performs data-type independent quality estimations that solve the problem associated with the existing methods. Furthermore, the disclosed system reduces the overall cost of the process of data quality estimation since it eliminates the need of employing different methods of data quality estimation for each different type of data.

The disclosed system can be utilized to identify both the positive and negative outcomes of data quality, which can help organizations improve the accuracy and completeness of the data that is fed into their training models. Generally, the positive outcomes of data quality refer to the beneficial effects that arise when data is accurate, complete, and consistent whereas the negative outcomes refer to the detrimental effects that arise when the data is inaccurate, incomplete, and inconsistent. Such beneficial effects include accurate decision-making, accurate model training, improved efficiency of the trained model, and the like whereas the detrimental effects include poor decision-making, inaccurate model training, poor efficiency of the trained model, and the like. The disclosed system can be further used to ensure that the quality of the data is greater than or equal to a threshold quality (high-quality data) that indicates the data is high-quality data. The high-quality data refers to the data that is accurate, reliable, complete, and consistent. Alternatively, the disclosed system is further used to ensure that the quality of the data is not less than a threshold quality (poor-quality data or low-quality data). The low-quality data (or the poor-quality data) refers to the data that is inaccurate, incomplete, and inconsistent.

The high-quality data enhances the performance of machine learning models, leading to more accurate predictions and classifications. Additionally, the high-quality data fosters improved decision-making within organizations, as reliable insights derived from trustworthy data can guide strategic planning and operational efficiencies. Moreover, the high-quality data reduces the cost of extensive data cleaning and rework, allowing teams to focus more on model optimization and feature engineering.

The high-quality data enhances the performance and speed of machine learning models (ML). If the data is accurate, complete, and consistent (i.e. high-quality data), the ML models can learn more effectively during the training phase, which leads to faster convergence and reduced training time. This efficiency allows for quicker iterations in model development, enabling organizations to deploy models more rapidly and respond to market changes. Additionally, the high-quality data reduces the computational time associated with cleaning and preprocessing. When data is already of high quality, less time and computational resources are spent on data preprocessing, allowing for more focus on model optimization and feature engineering. Furthermore, the ML models trained on the high-quality data tend to generalize better to unseen data, which enhances their performance in real-world applications. This improved generalization can lead to lower error rates and higher accuracy, which are critical for applications requiring precise predictions.

The disclosed system can be further utilized in the development pipelines that can help in identifying data quality issues which can be used as feedback to data scientists for further investigation to mitigate downstream issues such as inaccurate data analysis, operational inefficiencies, and the like. The disclosed system enhances operational efficiency by streamlining the data preparation process. For example, by pinpointing specific data quality issues, data scientists can focus their efforts on resolving the most critical problems rather than spending time on broader, less targeted data cleaning tasks.

Furthermore, the high-quality data, as indicated by the disclosed system, may enhance the performance (or the accuracy) of the machine learning models that may be trained on the high-quality data in comparison with the performance of the machine learning models that may be trained on the low-quality data. Specifically, the high-quality data leads to more accurate predictions and insights. Usually, machine learning models rely on the integrity of the input data; thus, cleaner datasets result in machine learning models that make better predictions. Also, with improved data quality, organizations can derive more meaningful insights from their analyses. The high-quality data (or Reliable data) enables predictive analytics that informs strategic decisions across various business functions. This capability is crucial for doing various tasks such as anticipating customer behavior and identifying operational inefficiencies. Also, the machine learning models that are equipped with high-quality data continuously learn from new inputs, thereby adapting their algorithms to improve over time. Such adaptability ensures that the machine learning models remain effective as they encounter evolving datasets, further enhancing their performance.

Moreover, by ensuring that only high-quality, relevant data is processed, machine learning models can operate more efficiently. The poor-quality data often leads to unnecessary computational overhead as models struggle with irrelevant or erroneous inputs. Also, with the high-quality data, tasks that typically take weeks can be accomplished in hours or days. This efficiency not only speeds up the data pipeline but also allows organizations to handle larger volumes of data without a proportional increase in resource consumption. Therefore, improved data quality directly enhances the performance and efficiency of machine learning models and data pipelines by increasing accuracy, expediting processing times, reducing computational burdens, enabling better decision-making, fostering continuous improvement, and facilitating proactive error management.

According to an embodiment of the disclosure, a computer-implemented method for data quality estimation using machine learning (ML) model is described. The computer-implemented method includes receiving, by a computer, an input dataset including one or more heterogeneous datasets from one or more data sources. Each heterogeneous dataset of the one or more heterogeneous datasets includes one or more data items. The computer-implemented method further includes applying, by the computer, an attention-based machine learning (ML) model to the input dataset. The computer-implemented method further includes calculating, by the computer, one or more first probability scores associated with the one or more heterogeneous datasets based on the application of the attention-based ML model to the input dataset. Each first probability score of the one or more first probability scores is associated with the one or more data items of a respective heterogeneous dataset of the one or more heterogeneous datasets. The computer-implemented method further includes determining, by the computer, one or more encoding matrices associated with the one or more heterogeneous datasets based on the one or more first probability scores associated with the one or more heterogeneous datasets. The computer-implemented method further includes applying, by the computer, a probabilistic operation on the one or more encoding matrices associated with the one or more heterogeneous datasets. The computer-implemented method further includes determining, by the computer, a quality score associated with the input dataset based on the application of the probabilistic operation on the one or more encoding matrices associated with the one or more heterogeneous datasets. The computer-implemented method further includes outputting, by the computer, the determined quality score.

In various embodiments of the disclosure, the one or more heterogeneous datasets include at least two of a categorical dataset, an ordinal dataset, a discrete dataset, or a continuous dataset.

In various embodiments of the disclosure, each first probability score of the one or more first probability scores associated with the one or more data items of the respective heterogeneous dataset corresponds to a positional encoding embedding of the one or more data items of the respective heterogeneous dataset of the one or more heterogeneous datasets.

In various embodiments of the disclosure, the computer-implemented method further includes calculating, by the computer, one or more second probability scores associated with the one or more heterogeneous datasets based on the one or more first probability scores. Each second probability score of the one or more second probability scores is associated with the one or more data items of the respective heterogeneous dataset of the one or more heterogeneous datasets. Each second probability score of the one or more second probability scores is calculated based on a respective first probability score of the one or more first probability scores. The computer-implemented method further includes determining, by the computer, one or more probabilistic data vectors associated with the one or more heterogeneous datasets based on the one or more second probability scores associated with the one or more heterogeneous datasets. The computer-implemented method further includes determining, by the computer, a probability distribution associated with the input dataset based on the one or more probabilistic data vectors. The computer-implemented method further includes determining, by the computer, the quality score associated with the input dataset based on the probability distribution.

In various embodiments of the disclosure, the computer-implemented method further includes transforming, by the computer, the input dataset into a lexicographical network graph based on the probability distribution associated with the input dataset. The lexicographical network graph corresponds to a force-directed network chart of the input dataset. The computer-implemented method further includes outputting, by the computer, the lexicographical network graph.

In various embodiments of the disclosure, the one or more second probability scores correspond to a log-likelihood score of the one or more data items of a first heterogeneous dataset of the one or more heterogeneous datasets co-occurring with the one or more data items of a second heterogeneous dataset of the one or more heterogeneous datasets.

In various embodiments of the disclosure, the quality score associated with the input dataset corresponds to a mean value of the probability distribution associated with the input dataset.

In various embodiments of the disclosure, the computer-implemented method further includes generating, by the computer, a beta probability density distribution graph associated with the input dataset based on the probability distribution associated with the input dataset. The computer-implemented method further includes determining, by the computer, the quality score associated with the input dataset based on the beta probability density distribution graph.

In various embodiments of the disclosure, the computer-implemented method further includes applying, by the computer, a statistical test on the beta probability density distribution graph associated with the input dataset. The computer-implemented method further includes validating, by the computer, the beta probability density distribution graph associated with the input dataset based on the application of the statistical test on the beta probability density distribution graph. The computer-implemented method further includes outputting, by the computer, the determined quality score based on the validation.

In various embodiments of the disclosure, the statistical test corresponds to one of an Anderson-Darling test or a Cramér-von Mises test.

In various embodiments of the disclosure, the computer-implemented method further includes determining, by the computer, the quality score associated with the input dataset is greater than or equal to a threshold quality score. The computer-implemented method further includes outputting, by the computer, the input dataset based on the determination that the quality score associated with the input dataset is greater than or equal to the threshold quality score.

In various embodiments of the disclosure, the computer-implemented method further includes training, by the computer, a machine learning (ML) model on the input dataset based on the determination that the quality score associated with the input dataset is greater than or equal to the threshold quality score. The ML model is trained to predict an output value based on an input value. The ML model is different from the attention-based ML model.

In various embodiments of the disclosure, the computer-implemented method further includes determining, by the computer, the quality score associated with the input dataset is less than a threshold quality score. The computer-implemented method further includes applying, by the computer, one or more data processing techniques on the input dataset based on the determination that the quality score associated with the input dataset is less than the threshold quality score. The computer-implemented method further includes outputting, by the computer, the input dataset based on the application of the one or more data processing techniques on the input dataset.

In various embodiments of the disclosure, the one or more data processing techniques include at least one of a data seeding technique or an imputation-based data cleaning technique.

According to one or more embodiments of the disclosure, a computer system for data quality estimation using machine learning (ML) model is described. The computer system includes a processor set, one or more computer-readable storage media, program instructions stored on the one or more computer-readable storage media. The program instructions are executable by the processor set and cause the processor set to receive an input dataset that includes one or more heterogeneous datasets from one or more data sources. Each heterogeneous dataset of the one or more heterogeneous datasets includes one or more data items. The program instructions further cause the processor set to apply an attention-based machine learning (ML) model to the input dataset. The program instructions further cause the processor set to calculate one or more first probability scores associated with the one or more heterogeneous datasets based on the application of the attention-based ML model to the input dataset. Each first probability score of the one or more first probability scores is associated with the one or more data items of a respective heterogeneous dataset of the one or more heterogeneous datasets. The program instructions further cause the processor set to determine one or more encoding matrices associated with the one or more heterogeneous datasets based on the one or more first probability scores associated with the one or more heterogeneous datasets. The program instructions further cause the processor set to apply a probabilistic operation on the one or more encoding matrices associated with the one or more heterogeneous datasets. The program instructions further cause the processor set to determine a quality score associated with the input dataset based on the application of the probabilistic operation on the one or more encoding matrices associated with the one or more heterogeneous datasets. The program instructions further cause the processor set to output the determined quality score.

In various embodiments of the disclosure, the program instructions further cause the processor set to calculate one or more second probability scores associated with the one or more heterogeneous datasets based on the one or more first probability scores. Each second probability score of the one or more second probability scores is associated with the one or more data items of the respective heterogeneous dataset of the one or more heterogeneous datasets. Each second probability score of the one or more second probability scores is calculated based on a respective first probability score of the one or more first probability scores. The program instructions further cause the processor to determine one or more probabilistic data vectors associated with the one or more heterogeneous datasets based on the one or more second probability scores associated with the one or more heterogeneous datasets. The program instructions further cause the processor to determine a probability distribution associated with the input dataset based on the one or more probabilistic data vectors. The program instructions further cause the processor to determine the quality score associated with the input dataset based on the probability distribution.

In various embodiments of the disclosure, the program instructions further cause the processor set to generate a beta probability density distribution graph associated with the input dataset based on the probability distribution associated with the input dataset. The program instructions further cause the processor to apply a statistical test on the beta probability density distribution graph associated with the input dataset. The program instructions further cause the processor to validate the beta probability density distribution graph associated with the input dataset based on the application of the statistical test on the beta probability density distribution graph. The program instructions further cause the processor to output the determined quality score based on the validation.

In various embodiments of the disclosure, the program instructions further cause the processor set to determine the quality score associated with the input dataset is greater than or equal to a threshold quality score. The program instructions further cause the processor to output the input dataset based on the determination that the quality score associated with the input dataset is greater than or equal to the threshold quality score.

In various embodiments of the disclosure, the program instructions further cause the processor set to determine the quality score associated with the input dataset is less than a threshold quality score. The program instructions further cause the processor set to apply one or more data processing techniques on the input dataset based on the determination that the quality score associated with the input dataset is less than the threshold quality score. The one or more data processing techniques include at least one of a data seeding technique or an imputation-based data cleaning technique. The program instructions further cause the processor set to output the input dataset based on the application of the one or more data processing techniques on the input dataset.

According to one or more embodiments of the disclosure, a computer program product for data quality estimation using machine learning (ML) model is described. The computer program product includes one or more computer-readable storage media and program instructions stored in the one or more computer-readable storage media to perform operations that include receiving an input dataset that includes one or more heterogeneous datasets from one or more data sources. Each heterogeneous dataset of the one or more heterogeneous datasets includes one or more data items. The operations further include applying an attention-based machine learning (ML) model to the input dataset. The operations further include calculating one or more first probability scores associated with the one or more heterogeneous datasets based on the application of the attention-based ML model to the input dataset. Each first probability score of the one or more first probability scores is associated with the one or more data items of a respective heterogeneous dataset of the one or more heterogeneous datasets. The operations further include determining one or more encoding matrices associated with the one or more heterogeneous datasets based on the one or more first probability scores associated with the one or more heterogeneous datasets. The operations further include applying a probabilistic operation on the one or more encoding matrices associated with the one or more heterogeneous datasets. The operations further include determining a quality score associated with the input dataset based on the application of the probabilistic operation on the one or more encoding matrices associated with the one or more heterogeneous datasets. The operations further include outputting the determined quality score.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks are performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium is an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

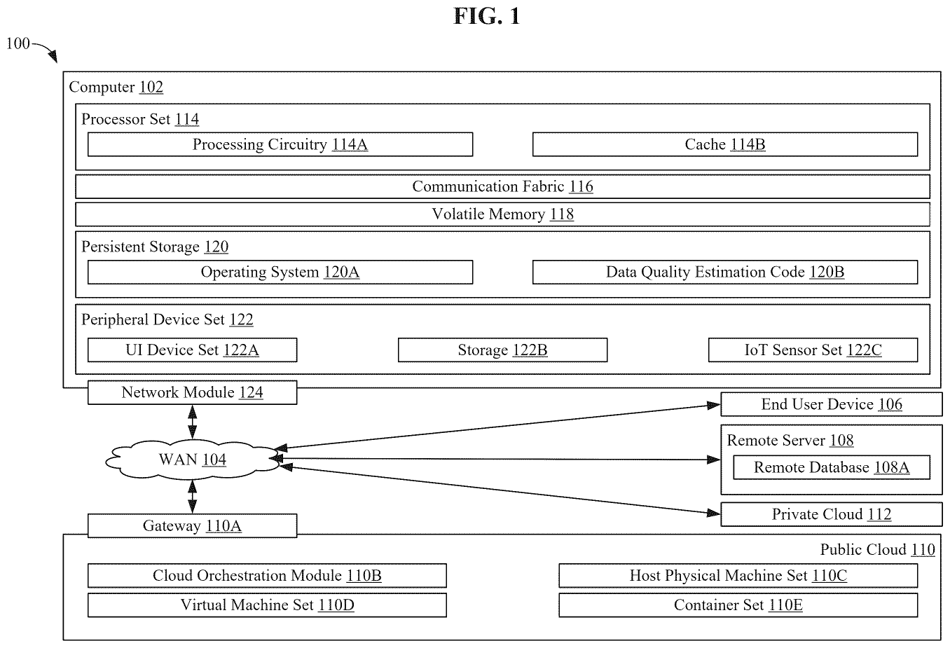

FIG. 1 is a diagram that illustrates a computing environment for data quality estimation using machine learning (ML) models, in accordance with an embodiment of the disclosure. With reference to FIG. 1, there is shown a computing environment 100 that contains an example of an environment for the execution of at least some of the computer code involved in performing the disclosed methods, such as a data quality estimation code 120B. In addition to the data quality estimation code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the data quality estimation code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as is affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B is a memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the storage media discussed below. The program instructions, and associated data, are accessed by the processor set 114 to control and direct the performance of the disclosed methods. In computing environment 100, at least some of the instructions for performing the disclosed methods may be stored in the dynamic modification of the data quality estimation code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths are used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 is a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the data quality estimation code 120B typically includes at least some of the computer code involved in performing the disclosed methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A includes components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B is persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

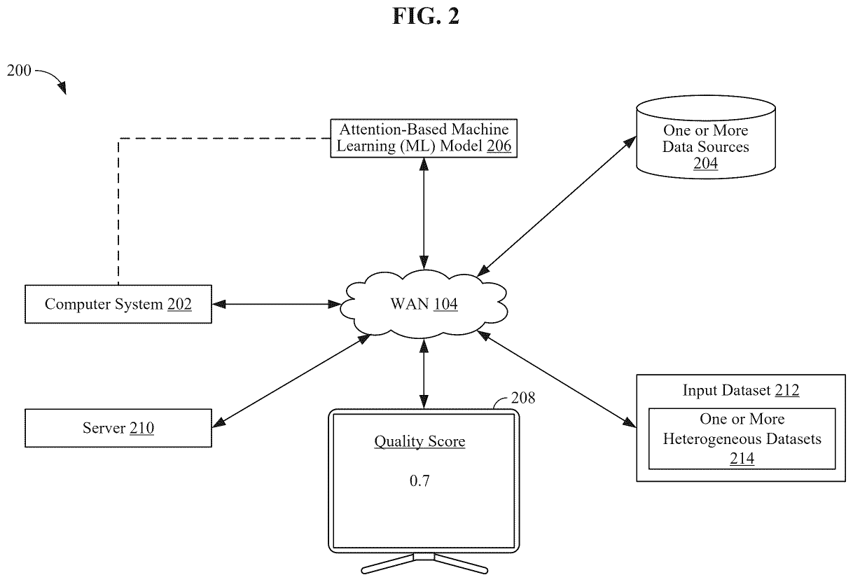

FIG. 2 is a diagram that illustrates an environment for data quality estimation using machine learning (ML) model, in accordance with an embodiment of the disclosure. FIG. 2 is explained in conjunction with elements from FIG. 1. With reference to FIG. 2, there is shown a diagram of a network environment 200. The network environment 200 includes a computer system 202, one or more data sources 204, an attention-based machine learning (ML) model 206, a user device 208, and a server 210. With reference to FIG. 2, there is further shown an input dataset 212 that includes one or more heterogeneous datasets 214. The network environment 200 further includes the WAN 104 of FIG. 1. In an embodiment of the disclosure, the computer system 202 is an exemplary embodiment of the computer 102 in FIG. 1. Similarly, in an embodiment of the disclosure, the user device 208 is an exemplary embodiment of the EUD 106 of FIG. 1.

The computer system 202 includes suitable logic, circuitry, and/or interfaces for data quality estimation using the ML model. The computer system 202 receives the input dataset 212 that includes one or more heterogeneous datasets 214 from the one or more data sources 204. Each heterogeneous dataset of the one or more heterogeneous datasets 214 includes one or more data items. The computer system 202 further applies the attention-based ML model 206 to the input dataset 212. The computer system 202 further determines one or more first probability scores associated with the one or more heterogeneous datasets 214 based on the application of the attention-based ML model to the input dataset 212. Each first probability score of the one or more first probability scores is associated with the one or more data items of a respective heterogeneous dataset of the one or more heterogeneous datasets 214. The computer system 202 further determines one or more encoding matrices associated with the one or more heterogeneous datasets 214 based on the one or more first probability scores associated with the one or more heterogeneous datasets 214. The computer system 202 further applies a probabilistic operation on the one or more encoding matrices associated with the one or more heterogeneous datasets 214. The computer system 202 further determines the quality score associated with the input dataset 212 based on the application of the probabilistic operation on the one or more encoding matrices associated with the one or more heterogeneous datasets 214. The computer system 202 further outputs the determined quality score.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. In an exemplary embodiment of the disclosure, the computer system 202 may be embodied as a cloud-based service, a cloud-based application, a cloud-based platform, a remote server-based service, a remote server-based application, a remote server-based platform, or a virtual computing system.

Each of the one or more data sources 204 corresponds to an organized collection of data that may be stored and accessed electronically from a computer system (such as the computer system 202). Each of the one or more data sources 204 may be designed to manage, store, retrieve, and update the input dataset 212 efficiently. In an exemplary implementation, each data source of the one or more data sources 204 may correspond to a database. In such an implementation, the structure of the database corresponding to each data source of the one or more data sources 204 typically involves tables, records, and fields that can be managed through various database management systems (DBMS).

In an embodiment of the disclosure, each of the one or more data sources 204 stores the input dataset 212 that includes the one or more heterogeneous datasets 214. Specifically, the one or more data sources 204 may be connected with the application programming interfaces (APIs) of one or more data warehouses associated with one or more organizations working under different domains such as healthcare, finance, marketing, manufacturing, education, and the like. In an embodiment of the disclosure, the one or more data sources 204 obtains the input dataset 212 using the APIs of various data warehouses associated with organizations working under these different domains. Examples of each of one or more data sources 204 may include but are not limited to, a relational database, a Non-Structured Query Language (SQL) database, a hierarchical database, a network database, a transactional database, a data warehouse, and a distributed database.

The attention-based ML model 206 may be a sophisticated piece of software that utilizes attention mechanisms alongside natural language processing (NLP) and machine learning techniques to understand, generate, and manipulate human language and generate embedding vectors that represent relationships between words in an input sequence. For example, the attention-based ML model 206 may correspond to an attention-based machine learning model specifically designed to enhance the processing and understanding of sequential data by effectively focusing on relevant portions of the input. Key characteristics of the attention-based model may include, but are not limited to, attention mechanisms, contextual awareness, dynamic weighting of inputs, and improved handling of long-range dependencies. For example, attention-based models can be implemented using various architectures such as Transformers and their derivatives.

Furthermore, the attention-based model is a specialized ML model that employs attention mechanisms to selectively prioritize information from input sequences, which facilitates more nuanced learning and interpretation of data. Such models have become integral in various applications, notably in natural language processing, image recognition, and time-series analysis, owing to their ability to focus on the most salient features of the input while discarding less relevant information.

Typically, attention-based models are characterized by their capability to compute attention scores that indicate the significance of different parts of an input sequence, thereby allowing the model to adaptively emphasize the most pertinent information during processing. This mechanism enhances the model's ability to understand context and relationships within the data, improving performance across tasks such as translation, summarization, and question-answering.

For instance, the attention mechanism in these models allows for effective handling of long-range dependencies, where traditional models might struggle. By utilizing weighted combinations of inputs, attention-based models can capture complex relationships and contextual nuances that are crucial for accurate interpretation. This is particularly useful in scenarios where the relevant information is dispersed throughout a lengthy input sequence.

Recently, the adoption of attention-based models has surged across various fields, driven by their effectiveness in improving model performance and interpretability. These models often require substantial computational resources for training; therefore, pre-trained attention-based models are commonly used as foundational layers for specific tasks. Pre-training typically involves exposure to large datasets, enabling the model to learn broad attention patterns that can be fine-tuned for targeted applications.

In this context, a base attention model refers to a trained model that has been developed on extensive data to learn generalized attention mechanisms. This foundational model captures diverse attention patterns and is applicable across various domains. While the base model serves as a robust starting point, it can be enhanced through fine-tuning for specific applications, thereby maximizing its utility in specialized tasks.

Additionally, an adapter module may be incorporated to facilitate the adaptation of the base attention model for specific applications. The adapter consists of a lightweight set of parameters trained on targeted data, while the majority of the base attention model's parameters remain unchanged. This approach enables efficient task-specific customization without the need for extensive retraining, making it particularly advantageous in resource-constrained environments.

In an embodiment of the disclosure, the attention-based ML model 206 determines one or more positional encoding embeddings associated with the one or more heterogeneous datasets 214. Specifically, the attention-based ML model 206 applies an attention algorithm on the input dataset 212 to determine the one or more positional encoding embeddings associated with the one or more data items of the respective heterogeneous dataset of the one or more heterogeneous datasets 214. Each positional encoding embedding of the one or more positional encoding embeddings is a vector including decimal values that indicates the intra-positional probability of occurrence of the one or more data items within the respective heterogeneous dataset of the one or more heterogeneous datasets 214. In an embodiment of the disclosure, the computer system 202 stores the attention-based ML model 206. In an alternate embodiment of the disclosure, the attention-based ML model 206 is embodied as a cloud-based service, a cloud-based application, or a cloud-based platform.

The user device 208 includes suitable logic, circuitry, and/or interfaces that are configured to execute one or more tasks within the network environment 200. The user device 208 performs the one or more tasks such as receiving data, processing the data, and transmitting the data. In an embodiment of the disclosure, the computer system 202 renders the determined quality score associated with the input dataset 212 on the user device 208. Examples of the user device 208 include one of but are not limited to, a smartphone, a cellular phone, a mobile phone, a consumer electronic (CE) device, an Internet of Things (IOT) device, a computing device, a mainframe machine, a server, a computer workstation, or the like.

The server 210 includes suitable logic, circuitry, interfaces, and/or code that stores the input dataset 212 which includes the one or more heterogeneous datasets 214. The server 210 further stores the attention-based ML model 206. In an alternate embodiment, the server 210 stores the quality score associated with the input dataset 212. The server 210 can be implemented as a cloud server and may execute operations through web applications, cloud applications, HTTP requests, repository operations, file transfer, and the like. Example implementations of the server 210 include, but are not limited to, a database server, a file server, a web server, a media server, an application server, a mainframe server, or a cloud computing server.

In an embodiment of the disclosure, the server 210 is implemented as a plurality of distributed cloud-based resources by use of several technologies that are well known to those ordinarily skilled in the art. A person with ordinary skill in the art will understand that the scope of the disclosure may not be limited to the implementation of the server 210 and the computer system 202 as two separate entities. In certain embodiments, the functionalities of the server 210 can be incorporated in its entirety or at least partially in the computer system 202, without a departure from the scope of the disclosure.

In operation, the computer system 202 receives the input dataset 212 which includes one or more heterogeneous datasets 214. In an embodiment of the disclosure, the computer system 202 receives the input dataset 212 from the one or more data sources 204. In an embodiment, the one or more data sources 204 may correspond to one or more data warehouses associated with the one or more organizations working under different domains such as healthcare, finance, marketing, manufacturing, education, and the like. In such an implementation, the computer system 202 may be connected with the one or more data sources using the application programming interfaces (APIs).

In an embodiment of the disclosure, each heterogeneous dataset of the one or more heterogeneous datasets 214 includes the one or more data items. Specifically, the one or more heterogeneous datasets 214 include at least one of a categorical dataset, an ordinal dataset, a discrete dataset, or a continuous dataset. The categorical dataset corresponds to a dataset in which each data item of the dataset is distributed into one or more categories. The ordinal dataset is a dataset in which each data item of the dataset is distributed into one or more categories and has a meaningful order or ranking among the one or more categories. The discrete dataset is a dataset in which the numerical data items of the dataset include only whole numbers and not any fractional value or any decimal value. The continuous dataset is a dataset in which the numerical data items include whole numbers as well as fractional values and decimal values.

In an exemplary embodiment of the disclosure, the computer system 202 receives the input dataset 212 that includes a first heterogeneous dataset (the categorical dataset) [“AssetID234”, “Colorado”, “ABC”, “XX234”] in which the first data item indicates a unique identifier of a car, the second data item indicates a location where the car is manufactured, the third data item indicates the manufacturer of the car, and the fourth data item indicates a model number associated with a car. The input dataset 212 further includes a second heterogeneous dataset (the ordinal dataset) [A, B, C, D] in which each data item indicates a grade of a student across four different subjects (arranged in order from best to worst). The input dataset 212 further includes a third heterogeneous dataset (the discrete dataset) including numerical data items as whole numbers, for example, [1, 2, 3, 4], and a fourth heterogeneous dataset (the continuous dataset) including numerical data items as decimal numbers, for example, [1.5979, 0.4456, 34.44546, 14.56].

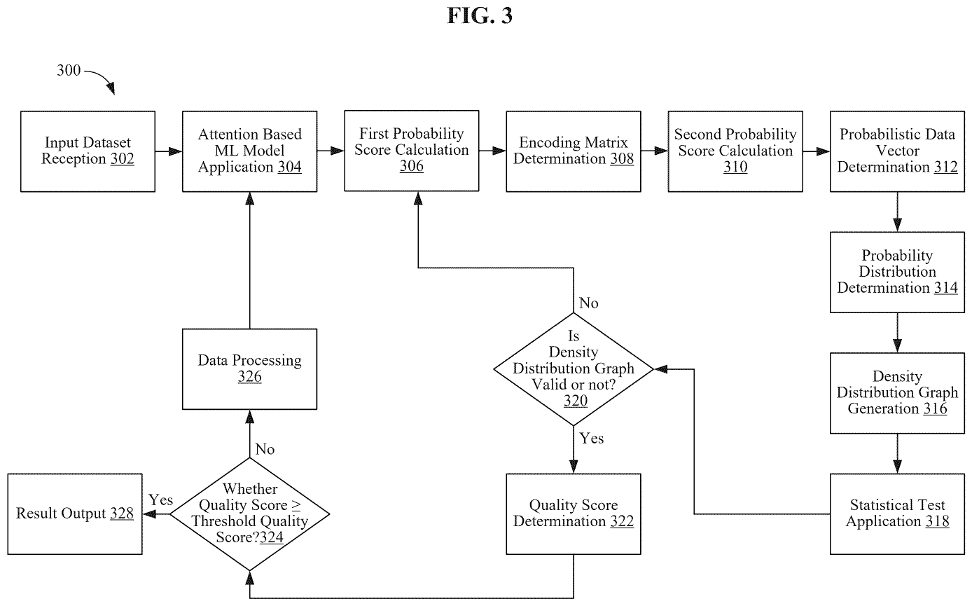

Thereafter, the computer system 202 applies the attention-based ML model 206 to the input dataset 212. The attention-based ML model 206 is the trained model. The attention-based ML model 206 applies the attention algorithm to the input dataset 212 which includes the one or more heterogeneous datasets 214. The attention-based ML model 206 applies the attention algorithm in which the attention-based ML model 206 identifies patterns and relationships based on its training data and determines the one or more positional encoding embeddings associated with the one or more heterogeneous datasets 214. The positional encoding embedding is a vector of decimal values that represents the positional information of a word in a sequence. Specifically, the positional encoding embedding indicates the relationships between different words in a sequence. Each positional encoding embedding of the one or more positional encoding embeddings is associated with the one or more data items of the respective heterogeneous dataset of the one or more heterogeneous datasets 214. Each positional encoding embedding of the one or more positional encoding embeddings is a vector of decimal values that indicates the intra-positional probability of occurrence of the one or more data items within the respective heterogeneous dataset. Details about the attention-based ML model application are further provided, for example, in FIG. 3.

Further, the computer system 202 calculates the one or more first probability scores associated with the one or more heterogeneous datasets 214 based on the application of the attention-based ML model 206 to the input dataset 212. Each first probability score of the one or more first probability scores is associated with the one or more data items of the respective heterogeneous dataset of the one or more heterogeneous datasets 214. In an embodiment of the disclosure, the computer system 202 calculates the one or more first probability scores associated with the one or more data items of the respective heterogeneous dataset based on normalizing each positional encoding embedding of the one or more positional encoding embeddings which is obtained from the application of the attention-based ML model 206. For example, if a specific positional encoding embedding of a specific data item is for example, [0.1, 0.2, −0.79, 0.3], then the computer system 202 normalizes the positional encoding value to keep the value between a range of 0 to 1 (probabilities are defined only in the range between 0 to 1) to determine the first probability score of occurrence of the specific data item within the respective heterogeneous dataset as [0.1, 0.2, 0.79, 0.3]. Details about the one or more first probability score calculation operations are further provided, for example, in FIG. 3.

Thereafter, the computer system 202 determines the one or more encoding matrices associated with the one or more heterogeneous datasets 214 based on the one or more first probability scores. Each encoding matrix of the one or more encoding matrices is associated with the respective heterogeneous dataset of the one or more heterogeneous datasets 214. The computer system 202 determines each encoding matrix of the one or more encoding matrices by combining the respective first probability score of the one or more probability scores that are associated with the one or more data items of the respective heterogeneous dataset. Each encoding matrix associated with the respective heterogeneous dataset includes each probability score of the one or more first probability scores associated with the one or more data items of the respective heterogeneous dataset. Details about the encoding matrix determination operation are further provided, for example, in FIG. 3.

Further, the computer system 202 applies the probabilistic operation on the one or more encoding matrices associated with the one or more heterogeneous datasets 214. In an embodiment of the disclosure, the computer system 202 applies the probabilistic technique to calculate one or more second probability scores associated with the one or more heterogeneous datasets 214 based on the one or more first probability scores associated with the one or more heterogeneous datasets 214. Each second probability score of the one or more second probability scores is associated with the one or more data items of the respective heterogeneous dataset of the one or more heterogeneous datasets 214. Each second probability score of the one or more second probability scores indicate a value of the inter-matrix probability of the one or more data items of the respective heterogeneous dataset of the one or more heterogeneous datasets 214. Specifically, each second probability score associated with the one or more data items of a first heterogeneous dataset of the one or more heterogeneous datasets 214 indicates the inter-matrix probability of co-occurrence of the one or more data items of the first heterogeneous dataset with one or more data items of a second heterogeneous dataset within the one or more heterogeneous datasets 214. Details about the second probability score calculation operation are further provided, for example, in FIG. 3.

Thereafter, the computer system 202 determines the quality score associated with the input dataset 212 based on the application of the probabilistic operation on the one or more encoding matrices associated with the one or more heterogeneous datasets 214. In an embodiment of the disclosure, the computer system 202 determines one or more probabilistic data vectors associated with the one or more heterogeneous datasets 214 based on the one or more second probability scores associated with the one or more heterogeneous datasets 214. Each probabilistic data vector of the one or more probabilistic data vectors is associated with the one or more data items of the respective heterogeneous dataset of the one or more heterogeneous datasets 214. In an embodiment of the disclosure, the computer system 202 determines each probabilistic data vector based on combining the respective second probability score of the one or more second probability scores associated with the one or more data items of the respective heterogeneous dataset. Each probabilistic data vector associated with the respective heterogeneous dataset includes the respective second probability score of the one or more second probability scores associated with the one or more data items of the respective heterogeneous dataset. Details about the probabilistic data vector determination are further provided, for example, in FIG. 3.

In an embodiment of the disclosure, the computer system 202 further determines a probability distribution associated with the input dataset 212 based on the one or more probabilistic data vectors associated with the one or more heterogeneous datasets 214. The probability distribution associated with the input dataset 212 includes the one or more probabilistic data vectors associated with the one or more heterogeneous datasets 214. In an embodiment of the disclosure, the computer system 202 further determines the quality score associated with the input dataset 212 based on calculating a mean value of the probability distribution associated with the input dataset 212. In an embodiment of the disclosure, the quality score associated with the input dataset 212 corresponds to the mean value of the probability distribution associated with the input dataset 212. In an embodiment of the disclosure, the computer system 202 utilizes the combination of the one or more first probability scores and the one or more second probability scores to determine the quality score that increases the accuracy and the reliability of the data quality estimation (the determination of the quality score associated with the input dataset 212) and helps in identifying the additional data quality issues such as data inconsistency, data redundancy, and data inaccuracies present in the input dataset 212. Details about the probability distribution determination operation and the quality score determination operation are further provided, for example, in FIG. 3.

To this end, the computer system 202 further outputs the quality score associated with the input dataset 212. In an embodiment of the disclosure, the computer system 202 renders the determined quality score associated with the input dataset 212 on the user device 208. Details about the result output operation are further provided, for example, in FIG. 3.

FIG. 3 is a diagram that illustrates exemplary operations for data quality estimation using a machine learning (ML) model, in accordance with an embodiment of the disclosure. FIG. 3 is explained in conjunction with elements from FIG. 1 and FIG. 2. With reference to FIG. 3, there is shown a block diagram 300 that illustrates exemplary operations from 302 to 328, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, an input dataset 212 reception operation is performed. In the input dataset 212 reception operation, the computer system 202 receives the input dataset 212 that includes one or more heterogeneous datasets 214. Each heterogeneous dataset of the one or more heterogeneous datasets 214 includes the one or more data items. In an embodiment of the disclosure, the computer system 202 receives the input dataset 212 from the one or more data sources 204. In an embodiment, the one or more data sources 204 may correspond to one or more data warehouses associated with the one or more organizations working under different domains such as healthcare, finance, marketing, manufacturing, education, and the like. In such an implementation, the computer system 202 may be connected with the one or more data sources using the application programming interfaces (APIs).

In an embodiment of the disclosure, the one or more heterogeneous datasets 214 include at least two of a categorical dataset, an ordinal dataset, a discrete dataset, or a continuous dataset. The categorical dataset corresponds to a dataset in which each data item of the dataset is distributed into one or more categories. In an exemplary embodiment of the disclosure, the computer system 202 receives the input dataset 212 that includes a first heterogeneous dataset (the categorical dataset [“AssetID234”, “Colorado”, “ABC”, “XX234”]) in which the first data item indicates a unique identifier of a car, the second data item indicates a location where the car is manufactured, the third data item indicates the manufacturer of the car, and the fourth data item indicates a model number associated with a car. The ordinal dataset is a dataset in which each data item of the dataset is distributed into one or more categories and has a meaningful order or ranking among the one or more categories. In an exemplary embodiment of the disclosure, the input dataset 212 further includes a second heterogeneous dataset (the ordinal dataset [A, B, C, D]) in which each data item indicates a grade of a student across four different subjects (arranged in order from best to worst).

The discrete dataset is a dataset in which the numerical data items of the dataset include only whole numbers and not any fractional value or any decimal value. In an exemplary embodiment of the disclosure, the input dataset 212 further includes a third heterogeneous dataset (the discrete dataset including numerical data items as whole numbers, for example, [1, 2, 3, 4]). The continuous dataset is a dataset in which the numerical data items include whole numbers as well as fractional values and decimal values. In an exemplary embodiment of the disclosure, the input dataset 212 further includes a fourth heterogeneous dataset (the continuous dataset including numerical data items as decimal numbers, for example, [1.5979, 0.4456, 34.44546, 14.56]).

In an embodiment of the disclosure, the computer system 202 combines the one or more heterogeneous datasets 214 into a combined dataset. The combined dataset includes the one or more data items of each heterogeneous dataset of the one or more heterogeneous datasets 214. In an exemplary embodiment of the disclosure, the computer system 202 combines the first heterogeneous dataset ([“AssetID234”, “Colorado”, “ABC”, “XX234”]), the second heterogeneous dataset (the ordinal dataset [A, B, C, D]), the third heterogeneous dataset (the discrete dataset [1, 2, 3, 4]), and the fourth heterogeneous dataset (the continuous dataset [1.5979, 0.4456, 34.44546, 14.56]) into the combined dataset.

At 304, an attention-based ML model application operation is performed. In the attention-based ML model application operation, the computer system 202 applies the attention-based ML model 206 to the input dataset 212. The attention-based ML model 206 is the trained model. The attention-based ML model 206 applies the attention algorithm to the input dataset 212 which includes the one or more heterogeneous datasets 214. The attention-based ML model 206 applies the attention algorithm in which the attention-based ML model 206 identifies patterns and relationships based on its training data and determines the one or more positional encoding embeddings associated with the one or more heterogeneous datasets 214. Each positional encoding embedding of the one or more positional encoding embeddings is associated with the one or more data items of the respective heterogeneous dataset of the one or more heterogeneous datasets 214. Each positional encoding embedding of the one or more positional encoding embeddings is a vector of decimal values that indicates the intra-positional probability of occurrence of the one or more data items within the respective heterogeneous dataset.

In an embodiment of the disclosure, the computer system 202 determines each positional encoding embedding of the one or more positional encoding embeddings associated with the one or more heterogeneous datasets 214 in the form of an embedding vector. The embedding vector represents the intra-positional probability of the one or more data items in a specific heterogeneous dataset of the one or more heterogeneous datasets 214 using sine and cosine functions. Specifically, the embedding vector indicates the positional information associated with the one or more data items of the specific heterogeneous dataset. Each dimension of the embedding vector encodes a different frequency, which represents the intra-positional probability of the one or more data items at different positions within the specific heterogeneous dataset of the one or more heterogeneous datasets 214. In an embodiment of the disclosure, the attention-based ML model 206 applies the attention algorithm to calculate each positional encoding embedding of the one or more positional encoding embeddings in the form of the embedding vector using the equations (1) and (2) as described below:

$$P ( k , 2 i ) = sin ( \frac{k}{{n}^{\frac{2 i}{d}}} ) ( for even indices of the embedding vector ) \qquad ( 1 )$$

$$P ( k , 2 i + 1 ) = cos ( \frac{k}{{n}^{\frac{2 i}{d}}} ) ( for odd indices of the embedding vector ) \qquad ( 2 )$$

where,
k: Position of a specific data item within the specific heterogeneous dataset (0<k<size of the specific heterogenous dataset/2).
d: Dimension of the output embedding vector or the positional encoding embedding.
P(k, j): Position function for mapping a position k of the specific data item within the specific heterogeneous dataset to index (k, j) of the output positional encoding embedding.
n: User-defined scalar which can be, for example, 100.
i: Used for mapping to column indices of the output positional encoding embedding (0<i<d/2), with a single value of i maps to both sine and cosine functions.

In an exemplary embodiment of the disclosure, the computer system 202 applies the attention-based ML model 206 to the input dataset 212 to calculate the one or more positional encoding embeddings associated with the one or more data items of the first heterogeneous dataset (the categorical dataset [“AssetID234”, “Colorado”, “ABC”, “XX234”]). As discussed above, the attention-based ML model 206 utilizes the equations (1) and (2) to determine the embedding vector associated with, for example, the first data item of the first heterogeneous dataset (the categorical dataset “AssetID234”) as [P(0,0)=sin(0), P(0,1)=cos(0), P(0,2)=sin(0), P(0,3)=cos(0)] since the first data item has a position value of k as 0 within the first heterogeneous dataset and taking the dimension of the output embedding vector (d) as 4. The attention-based ML model 206 calculates the positional encoding embedding associated with the first data item of the first heterogeneous dataset as [0, 1, 0, 1].

Similarly, the attention-based ML model 206 further utilizes the equations (1) and (2) to determine the embedding vector associated with, for example, the second data item “Colorado” as [P(1,0)=sin(1), P(1,1)=cos(1), P(1,2)=sin( 1/10), P(1,3)=cos( 1/10)]. The attention-based ML model 206 calculates the positional encoding embedding associated with the second data item of the first heterogeneous dataset as [0.84, 0.54, 0.1, 1.0]. Similarly, the attention-based ML model 206 further utilizes the equations (1) and (2) to determine the embedding vector associated with, for example, the third data item “ABC” as [P(2,0)=sin(2), P(2,1)=cos(2), P(2,2)=sin( 2/10), P (2,3)=cos( 2/10)]. The attention-based ML model 206 calculates the positional encoding embedding associated with the third data item of the first heterogeneous dataset as [0.91, −0.42, 0.20, 0.98].

Similarly, the attention-based ML model 206 further utilizes the equations (1) and (2) to determine the embedding vector associated with, for example, the fourth data item “XX234” as [P(3,0)=sin(3), P(3,1)=cos(3), P(3,2)=sin( 3/10), P(3,3)=cos( 3/10)]. The attention-based ML model 206 calculates the positional encoding embedding associated with the fourth data item of the first heterogeneous dataset as [0.14, −0.99, 0.3, 0.96]. In an exemplary embodiment of the disclosure, the computer system 202 similarly applies the attention-based ML model 206 to calculate the one or more positional encoding embeddings associated with the one or more data items of the ordinal dataset [A, B, C, D], the one or more data items of the discrete dataset [1, 2, 3, 4], and the one or more data items of the continuous dataset [1.5979, 0.4456, 34.44546, 14.56], respectively, by utilizing the equations (1) and (2) as discussed above.

At 306, a first probability score calculation operation is performed. In the first probability score calculation operation, the computer system 202 calculates the one or more first probability scores associated with the one or more heterogeneous datasets 214 based on the application of the attention-based ML model 206 to the input dataset 212. Each first probability score of the one or more first probability scores is associated with the one or more data items of the respective heterogeneous dataset of the one or more heterogeneous datasets 214. In an embodiment of the disclosure, the computer system 202 calculates the one or more first probability scores associated with the one or more data items of the respective heterogeneous dataset based on normalizing each positional encoding embedding of the one or more positional encoding embeddings which is obtained from the application of the attention-based ML model 206. For example, if a specific positional encoding embedding of a specific data item is for example, [0.1, 0.2, −0.79, 0.3], then the computer system 202 normalizes the positional encoding value to keep the value between a range of 0 to 1 (probabilities are defined only in the range between 0 to 1) to determine the first probability score of occurrence of the specific data item within the respective heterogeneous dataset as [0.1, 0.2, 0.79, 0.3].

In an exemplary embodiment of the disclosure, the computer system 202 normalizes the positional encoding embedding associated with the third data item “ABC” of the categorical dataset [“AssetID234”, “Colorado”, “ABC”, “XX234”] since that positional encoding embedding includes a specific value as −0.42 as calculated above (probabilities are defined only in the range between 0 to 1). The computer system 202 normalizes the specific embedding value as 0.42 to lie between 0 and 1 and then determines the positional encoding embedding as [0.91, 0.42, 0.20, 0.98]. Similarly, the computer system 202 further normalizes the positional encoding embedding associated with the fourth data item “XX234” and determines the positional encoding embedding as [0.14, 0.99, 0.3, 0.96] after normalizing.

In an embodiment of the disclosure, the computer system 202 further normalizes the one or more positional encoding embeddings associated with the one or more data items of the respective heterogeneous dataset of the one or more heterogeneous datasets 214 based on the determination that the one or more positional encoding embeddings include a value lying outside the range of 0 to 1. In an exemplary embodiment of the disclosure, the computer system 202 further normalizes the one or more positional encoding embeddings associated with the one or more data items of the second heterogeneous dataset (the ordinal dataset [A, B, C, D]), the one or more data items of the third heterogeneous dataset (the discrete dataset [1, 2, 3, 4]), and the one or more data items of the fourth heterogeneous dataset (the continuous dataset [1.5979, 0.4456, 34.44546, 14.56]), respectively based on when the one or more positional encoding embeddings includes a value lying outside the range of 0 to 1.

In an embodiment of the disclosure, each first probability score of the one or more first probability scores associated with the one or more data items of the respective heterogeneous dataset corresponds to the positional encoding embedding of the one or more data items of the respective heterogeneous dataset of the one or more heterogeneous datasets 214. In an embodiment of the disclosure, each first probability score of the one or more first probability scores indicates the intra-matrix probability of occurrence of the one or more data items of a specific heterogeneous dataset within the specific heterogeneous dataset.

At 308, an encoding matrix determination operation is performed. In the encoding matrix determination operation, the computer system 202 determines the one or more encoding matrices associated with the one or more heterogeneous datasets 214 based on the one or more first probability scores. Each encoding matrix of the one or more encoding matrices is associated with the respective heterogeneous dataset of the one or more heterogeneous datasets 214. The computer system 202 determines each encoding matrix of the one or more encoding matrices based on combining the respective first probability score of the one or more probability scores that are associated with the one or more data items of the respective heterogeneous dataset. Each encoding matrix associated with the respective heterogeneous dataset includes each first probability score of the one or more first probability scores associated with the one or more data items of the respective heterogeneous dataset.

In an embodiment of the disclosure, the computer system 202 determines each encoding matrix of the one or more encoding matrices associated with the respective heterogeneous dataset based on combining the respective positional encoding embedding of the one or more positional encoding embeddings associated with the one or more data items of the respective heterogeneous dataset. In an exemplary embodiment of the disclosure, the computer system 202 determines the encoding matrix associated with the first heterogeneous dataset [“AssetID234”, “Colorado”, “ABC”, “XX234”] that can be represented as a Table 1 which is shown below:

TABLE 1
Encoding Matrix associated with First Heterogeneous Datase

| | | | | |
|---|---|---|---|---|
| “AssetID234” | 0 | 1 | 0 | 1 |
| “Colorado” | 0.84 | 0.54 | 0.1 | 1.0 |
| “ABC” | 0.91 | 0.42 | 0.2 | 0.98 |
| “XX234” | 0.14 | 0.99 | 0.3 | 0.96 |

In an exemplary embodiment of the disclosure, the computer system 202 similarly determines the encoding matrix associated with the second heterogeneous dataset (the ordinal dataset [A, B, C, D]), the third heterogeneous dataset (the discrete dataset [1, 2, 3, 4]), and the fourth heterogeneous dataset (the continuous dataset [1.5979, 0.4456, 34.44546, 14.56]) based on combining the one or more positional encoding embeddings of the one or more data items of the second heterogeneous dataset (the ordinal dataset [A, B, C, D]), the one or more positional encoding embeddings of the one or more data items of the third heterogeneous dataset (the discrete dataset [1, 2, 3, 4]), and the one or more positional encoding embeddings of the one or more data items of the fourth heterogeneous dataset (the continuous dataset [1.5979, 0.4456, 34.44546, 14.56]), respectively.

In an exemplary embodiment of the disclosure, the computer system 202 determines the encoding matrix associated with the second heterogeneous dataset that can be represented in Table 2 which is shown below:

TABLE 2
Encoding Matrix associated with Second Heterogeneous Dataset

| | | | | |
|---|---|---|---|---|
| A | 0 | 1 | 0 | 1 |
| B | 0.84 | 0.54 | 0.1 | 1.0 |
| C | 0.91 | 0.42 | 0.2 | 0.98 |
| D | 0.14 | 0.99 | 0.3 | 0.96 |

In an exemplary embodiment of the disclosure, the computer system 202 determines the encoding matrix associated with the third heterogeneous dataset that can be represented in Table 3 which is shown below:

TABLE 3
Encoding Matrix associated with Third Heterogeneous Dataset

| | | | | |
|---|---|---|---|---|
| 1 | 0 | 1 | 0 | 1 |
| 2 | 0.84 | 0.54 | 0.1 | 1.0 |
| 3 | 0.91 | 0.42 | 0.2 | 0.98 |
| 4 | 0.14 | 0.99 | 0.3 | 0.96 |

In an exemplary embodiment of the disclosure, the computer system 202 determines the encoding matrix associated with the fourth heterogeneous dataset that can be represented in Table 4 which is shown below:

TABLE 4
Encoding Matrix associated with Fourth Heterogeneous Dataset

| | | | | |
|---|---|---|---|---|
| 1.5979 | 0 | 1 | 0 | 1 |
| 0.4456 | 0.84 | 0.54 | 0.1 | 1.0 |
| 34.44546 | 0.91 | 0.42 | 0.2 | 0.98 |
| 14.56 | 0.14 | 0.99 | 0.3 | 0.96 |

At 310, a second probability score calculation operation is performed. In the second probability score calculation operation, the computer system 202 applies the probabilistic operation on the encoding matrix associated with each heterogeneous dataset of the one or more heterogeneous datasets 214. In an embodiment of the disclosure, the computer system 202 applies the probabilistic technique to calculate one or more second probability scores associated with the one or more heterogeneous datasets 214 based on the one or more first probability scores associated with the one or more heterogeneous datasets 214. In an embodiment of the disclosure, each second probability score of the one or more second probability scores are associated with the one or more data items of the respective heterogeneous dataset of the one or more heterogeneous datasets 214. Each second probability score of the one or more second probability scores indicate a value of the inter-matrix probability of the one or more data items of the respective heterogeneous dataset of the one or more heterogeneous datasets 214. Specifically, each second probability score associated with the one or more data items of a first heterogeneous dataset of the one or more heterogeneous datasets 214 indicates the inter-matrix probability of a co-occurrence of the one or more data items of the first heterogeneous dataset with one or more data items of a second heterogeneous dataset within the one or more heterogeneous datasets 214. In an embodiment of the disclosure, the co-occurrence may refer to the phenomenon where two or more data items appear together or occur simultaneously within a specific dataset.

In an embodiment of the disclosure, each second probability score of the one or more second probability scores are calculated based on the respective first probability score of the one or more first probability scores. In an embodiment of the disclosure, each second probability score of the one or more second probability scores correspond to a log-likelihood score of the one or more data items of the first heterogeneous dataset of the one or more heterogeneous datasets 214 co-occurring with the one or more data items of the second heterogeneous dataset of the one or more heterogeneous datasets 214. In an embodiment of the disclosure, the computer system 202 calculates the log-likelihood score of the respective first probability score of the first data item of the first heterogeneous dataset with the first probability score of a second data item of the second heterogeneous dataset to determine the second probability score of the first data item of the first dataset. In an embodiment of the disclosure, the computer system 202 similarly calculates the one or more second probability scores associated with the one or more data items of the one or more heterogeneous datasets 214 based on the respective first probability scores of the one or more first probability scores from the one or more encoding matrices.

In an embodiment of the disclosure, the computer system 202 applies the log-likelihood formula for calculating each second probability score of the one or more second probability scores associated with the one or more data items of the respective heterogeneous dataset of the one or more heterogeneous datasets 214. The log-likelihood formula for determining the inter-matrix probability of co-occurrence of one or more data items of the first heterogeneous dataset with the one or more data items of the second heterogeneous datasets within the one or more heterogeneous datasets 214 is described in equation (3) as follows:

$$LLR = 2 * N * H ( term 1 , term 2 , … termn ) + N * H ( ∼ term 1 , ∼ term 2 , … termn ) - N * H ( term 1 , ∼ term 2 , … termn ) - N * H ( ∼ term 1 , term 2 , … termn ) \qquad ( 3 )$$

where,
N: Represents the number of samples (the number of one or more first probability scores) in the one or more encoding matrices associated with the one or more heterogeneous datasets 214 (sample space).
H(term1, term2, . . . termn): Entropy value associated with the one or more heterogeneous datasets 214 when a first specific data item of a first specific heterogeneous dataset (term1) co-occurs with a second specific data item of a second specific heterogeneous dataset (term2) within the one or more heterogeneous datasets 214.
H(˜term1, ˜term2, . . . termn): Entropy value associated with the one or more heterogeneous datasets 214 when both the first specific data item of the first specific heterogeneous dataset (term1) and the second specific data item of the second specific heterogeneous dataset (term2) does not occur within the one or more heterogeneous datasets 214.
H(term1, ˜term2, . . . termn): Entropy value associated with the one or more heterogeneous datasets 214 when the first specific data item of the first specific heterogeneous dataset (term1) occurs but the second specific data item of the second specific heterogeneous dataset (term2) does not occur within the one or more heterogeneous datasets 214.
H(˜term1, term2, . . . termn): Entropy value associated with the one or more heterogeneous datasets 214 when the first specific data item of the first specific heterogeneous dataset (term1) does not occur but the second specific data item of the second specific heterogeneous dataset (term2) occurs within the one or more heterogeneous datasets 214.

In an exemplary embodiment of the disclosure, the computer system 202 determines the one or more second probability scores associated with the first heterogeneous dataset [“AssetID234”, “Colorado”, “ABC”, “XX234”]. As discussed above, the computer system 202 utilizes the log-likelihood formula described in equation (3) to determine the second probability score indicating the inter-matrix probabilities associated with the first data item “AssetID234” of the first heterogeneous dataset as, for example [0.8, 0.2, 0.7, 0.3]. Similarly, the computer system 202 utilizes the log-likelihood formula described in equation (3) to determine the second probability score indicating the intra-matrix probabilities associated with the second data item “Colorado” within the one or more heterogeneous datasets 214 as, for example [0.45, 0.55, 0.1, 0.9]. Similarly, the computer system 202 utilizes the log-likelihood formula described in equation (3) to determine the second probability score indicating the intra-matrix probabilities associated with the third data item “ABC” within the one or more heterogeneous datasets 214 as, for example [0.4, 0.6, 0.21, 0.79].

Similarly, the computer system 202 utilizes the log-likelihood formula described in equation (3) to determine the second probability score indicating the intra-matrix probabilities associated with the fourth data item “XX234” within the one or more heterogeneous datasets 214 as, for example [0.14, 0.76, 0.06, 0.94]. In an exemplary embodiment of the disclosure, the computer system 202 similarly utilizes the log-likelihood formula to determine the one or more second probability scores associated with the one or more data items of the second heterogeneous dataset (the ordinal dataset [A, B, C, D]), the one or more data items of the third heterogeneous dataset (the discrete dataset [1, 2, 3, 4]), and the one or more data items of the fourth heterogeneous dataset (the continuous dataset [1.5979, 0.4456, 34.44546, 14.56]). In an embodiment of the disclosure, the computer system 202 similarly determines the one or more second probability scores associated with the one or more data items of the respective heterogeneous dataset of the one or more heterogeneous datasets 214 using the log-likelihood formula as discussed above.

At 312, a probabilistic data vector determination operation is performed. In the probabilistic data vector determination operation, determines one or more probabilistic data vectors associated with the one or more heterogeneous datasets 214 based on the one or more second probability scores associated with the one or more heterogeneous datasets 214. Each probabilistic data vector of the one or more probabilistic data vectors is associated with the one or more data items of the respective heterogeneous dataset of the one or more heterogeneous datasets 214. In an embodiment of the disclosure, the computer system 202 determines each probabilistic data vector based on combining the respective second probability score of the one or more second probability scores associated with the one or more data items of the respective heterogeneous dataset. Each probabilistic data vector associated with the respective heterogeneous dataset includes the respective second probability score of the one or more second probability scores associated with the one or more data items of the respective heterogeneous dataset.

In an exemplary embodiment of the disclosure, the computer system 202 determines the probabilistic data vector associated with the first heterogeneous dataset [“AssetID234”, “Colorado”, “ABC”, “XX234”] represented in Table 5 as shown below:

TABLE 5
Probabilistic Data Vector of First Heterogenous Dataset

| | | | | |
|---|---|---|---|---|
| “AssetID234” | 0.8 | 0.2 | 0.7 | 0.3 |
| “Colorado” | 0.45 | 0.55 | 0.1 | 0.9 |
| “ABC” | 0.4 | 0.6 | 0.21 | 0.79 |
| “XX234” | 0.14 | 0.76 | 0.06 | 0.94 |

In an exemplary embodiment of the disclosure, the computer system 202 similarly determines the one or more probabilistic data vectors associated with the second heterogeneous dataset [A, B, C, D], the third heterogeneous dataset [1, 2, 3, 4], and the fourth heterogeneous dataset, [1.5979, 0.4456, 34.44546, 14.56] by combining each second probability score associated with the one or more data items of the second heterogeneous dataset (the ordinal dataset [A, B, C, D]), each second probability score associated with the one or more data items of the third heterogeneous dataset (the discrete dataset [1, 2, 3, 4]), and each second probability score associated with the one or more data items of the fourth heterogeneous dataset (the continuous dataset [1.5979, 0.4456, 34.44546, 14.56]), respectively.

At 314, a probability distribution determination operation is performed. In the probability distribution determination operation, the computer system 202 determines the probability distribution associated with the input dataset 212. In an embodiment of the disclosure, the computer system 202 determines the probability distribution associated with the input dataset 212 based on the one or more probabilistic data vectors associated with the one or more heterogeneous datasets 214. In an embodiment of the disclosure, the probability distribution associated with the input dataset 212 includes the one or more probabilistic data vectors associated with the one or more heterogeneous datasets 214.

In an embodiment of the disclosure, the computer system 202 further determines the mean value of the probability distribution associated with the input dataset 212, which is then used to determine the quality score associated with the input dataset 212. In an embodiment of the disclosure, the quality score associated with the input dataset 212 corresponds to the mean value of the probability distribution associated with the input dataset 212.

At 316, a density distribution graph generation operation is performed. In the density distribution graph generation operation, the computer system 202 generates the beta probability density distribution graph associated with the input dataset 212 based on the probability distribution associated with the input dataset 212. The beta probability density distribution graph is a continuous probability distribution graph defined on the interval [0,1] characterized by two positive shape parameters, α, and β, and the probability distribution function (PDF) [f(x; a, B)] of the probability distribution is described in the equation (4) as follows:

$$f ( x ; α , β ) = \frac{{{x}^{α - 1} ( 1 - x )}^{β - 1}}{B ( α , β )} for 0 < x < 1 \qquad ( 4 )$$

where,
X: represents the random variable X of the probability distribution associated with the input dataset 212. Also, x can take values from 0 to 1.
B(α, β) is the Beta function which normalizes the PDF and is represented as:

$$B ( α , β ) = \frac{Γ ( α ) Γ ( β )}{Γ ( α + β )} \qquad ( 5 )$$

and where,
Γ: is the gamma function defined as:

$$Γ ( x ) = {\int }_{0}^{∞} {t}^{x - 1} {e}^{- x} dt for x > 0 \qquad ( 6 )$$

In an embodiment of the disclosure, the computer system 202 determines the shape parameters α and β that fit the probability distribution based on a maximum likelihood estimation formula [L(α, β)] which is described in the equation (7) as follows:

$$L ( α , β ) = {\prod }_{i = 1}^{n} \frac{{{x}_{i}^{α - 1} ( 1 - {x}_{i} )}^{β - 1}}{B ( α , β )} \qquad ( 7 )$$

In an embodiment of the disclosure, the computer system 202 further converts the maximum likelihood estimation formula to a maximum log-likelihood estimation formula [log L(α, β)] for estimating the shape parameters which is described in the equation (8) as follows:

$$log L ( α , β ) = {\sum }_{i = 0}^{n} ( ( α - 1 ) log {x}_{i} + ( β - 1 ) log ( 1 - {x}_{i} ) - n log B ( α , β ) \qquad ( 8 )$$

In an embodiment of the disclosure, the computer system 202 further estimates a partial derivative of the maximum log-likelihood function [log L(α, β)] with respect to each of the shape parameters α and β and set them to zero to determine the two equations, equation (9) and equation (10) as follows:

$$\frac{\partial log L ( α , β )}{\partial α} = {\sum }_{i = 0}^{n} log \frac{{x}_{i}}{B ( α , β )} - \frac{{nτ}^{′} ( α ) B ( α , β ) - nτ ( α ) {B}^{′} ( α , β )}{{( B ( α , β ) )}^{2}} = 0 \qquad ( 9 )$$

$$\frac{\partial log L ( α , β )}{\partial β} = {\sum }_{i = 0}^{n} log \frac{{x}_{i}}{B ( α , β )} - \frac{{nτ}^{′} ( β ) B ( α , β ) - nτ ( β ) {B}^{′} ( α , β )}{{( B ( α , β ) )}^{2}} = 0 \qquad ( 10 )$$

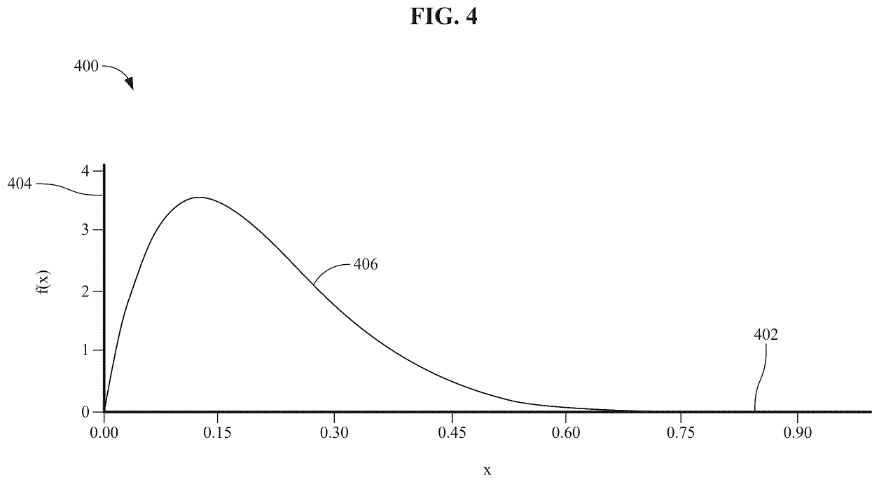

In an embodiment of the disclosure, the computer system 202 further solves the equations (9) and (10) to obtain the value of estimated shape parameters α and β. In an exemplary embodiment of the disclosure, the computer system 202 determines the value of shape parameters α=2 and β=8 that best fits the probability distribution. The computer system 202 further generates the beta probability density distribution graph associated with the input dataset 212 based on the formula of equation (4) using the value of shape parameters as α=2 and β=8. In an embodiment of the disclosure, the computer system 202 outputs the beta probability density distribution graph associated with the input dataset 212. Details about an exemplary beta probability density distribution graph are further provided in, for example, FIG. 4.

At 318, a statistical test application operation is performed. In the statistical test application operation, the computer system 202 applies a statistical test on the beta probability density distribution graph associated with the input dataset 212. In an embodiment of the disclosure, the computer system 202 applies a goodness of fit statistical test on the beta probability density distribution graph to validate the fit of the beta probability density distribution graph associated with the input dataset 212. The goodness of fit statistical test is a statistical procedure used to determine how well a set of observed data fits a specific theoretical distribution.

In an embodiment of the disclosure, the statistical test corresponds to one of an Anderson-Darling Test or a Cramer-von Mises test. In an embodiment of the disclosure, the computer system 202 applies the Anderson Darling goodness of fit test on the beta probability density distribution graph to validate the fit of the beta probability density distribution graph. In an embodiment of the disclosure, the computer system 202 initially determines the test parameters shape parameters α and β using the maximum likelihood estimation formula as discussed above.

In an embodiment of the disclosure, the computer system 202 further calculates the cumulative distribution function (CDF) for the probability distribution using the estimated shape parameters α and β. The CDF of a specific probability distribution gives the probability that the random variable X of the specific probability distribution is less than or equal to a certain value x, i.e., P(X≤x). The CDF of the probability distribution [F(x; α, β)] is calculated using the formula described in the equation (11) as follows:

$$F ( x ; α , β ) = {\int }_{- ∞}^{x} f ( t ; α , β ) dt \qquad ( 11 )$$

where,
f(t; α, β): is the probability distribution function (PDF) of the distribution as discussed above in equation (4).

In an embodiment of the disclosure, the computer system 202 further formulates a null hypothesis that the probability distribution fits the beta probability density distribution graph. In an alternate embodiment of the disclosure, the computer system 202 formulates an alternate hypothesis that the probability distribution does not fit the beta probability density distribution graph. In an embodiment of the disclosure, the computer system 202 further calculates the Anderson-Darling test statistic (A²) using the formula described in the equation (12) as follows:

$${A}^{2} = - n - \frac{1}{n} {\sum }_{i = 1}^{n} ( ( 2 i - 1 ) ( log F ( {x}_{i} ) + log ( 1 - F ( {x}_{n + 1 - i} ) ) ) ) \qquad ( 12 )$$

where,
n: is the sample space.
F(Xᵢ): is the cumulative distribution function (CDF) of the probability distribution as discussed above in equation (11).

In an embodiment of the disclosure, the computer system 202 further calculates the critical value from the statistical table which is specific to the Anderson-Darling Test based on the sample size of the probability distribution. In an embodiment of the disclosure, the computer system 202 calculates the critical value as 0.05. In an embodiment of the disclosure, the computer system 202 further compares the critical value with the calculated Anderson Darling Test Statistic (A²) based on the probability distribution to validate the fit of the beta probability density distribution graph.

In an alternate embodiment of the disclosure, the computer system 202 further applies the Cramér-von Mises goodness of fit test on the beta probability density distribution graph to validate the fit of the beta probability density distribution graph. In an embodiment of the disclosure, the computer system 202 initially determines the test parameters shape parameters α and β using the maximum likelihood estimation formula as discussed above.

In an embodiment of the disclosure, the computer system 202 further similarly formulates a null hypothesis that the probability distribution fits the beta probability density distribution graph. In an alternate embodiment of the disclosure, the computer system 202 similarly formulates an alternate hypothesis that the probability distribution does not fit the beta probability density distribution graph.

In an embodiment of the disclosure, the computer system 202 further calculates the cumulative distribution function (CDF) for the probability distribution using the equation (10) as discussed above. In an embodiment of the disclosure, the computer system 202 further calculates the empirical cumulative distribution function (ECDF) for the probability distribution using the formula described in equation (13) as follows:

$$ECDF ( x ) = \frac{number of points in the probability distribution < x}{n}$$

where,
n: is the sample space of the probability distribution.

In an embodiment of the disclosure, the computer system 202 further calculates the Cramer-von Mises test criterion W² based on the CDF and the ECDF of the probability distribution using the formula described in the equation (14) as follows:

$${W}^{2} = \frac{1}{n} {\sum }_{i = 1}^{n} {( ECDF ( {x}_{i} ) - F ( {x}_{i} ) )}^{2} \qquad ( 14 )$$

where,
F(Xᵢ): is the cumulative distribution function (CDF) of the probability distribution as discussed above in equation (11).
ECDF(Xᵢ): is the empirical cumulative distribution function (ECDF) of the probability distribution as discussed above in equation (13).

In an embodiment of the disclosure, the computer system 202 further calculates the critical value from the statistical table which is specific to the Cramer-von Mises test based on the sample size of the probability distribution. In an exemplary embodiment of the disclosure, the computer system 202 calculates the critical value as 0.05. In an embodiment of the disclosure, the computer system 202 further compares the critical value with the calculated Cramér-von Mises test criterion (W²) based on the probability distribution to validate the fit of the beta probability density distribution graph.

At 320, it may be determined whether the beta probability density distribution graph is valid or not. In an embodiment of the disclosure, the computer system 202 validates the beta probability density distribution graph based on the application of the statistical test on the beta probability density distribution graph. In an embodiment of the disclosure, the computer system 202 compares the critical value with the calculated Anderson Darling Test statistic (A²).

In an embodiment of the disclosure, the computer system 202 determines that the calculated Anderson Darling Test statistic (A²) is less than the critical value. In an embodiment of the disclosure, the computer system 202 further accepts the null hypothesis that the probability distribution fits the beta probability density distribution graph based on the determination that the calculated Anderson Darling Test Statistic (A²) is less than the critical value. In an embodiment of the disclosure, the control of operations proceeds to 322 based on the determination that the calculated Anderson Darling Test Statistic (A²) is less than the critical value otherwise the control of operations moves back to 306.

In an embodiment of the disclosure, the control of operations moves back to 306 based on the determination that the calculated Anderson Darling Test Statistic (A²) is greater than the critical value. In an embodiment of the disclosure, the computer system further iteratively re-calculates the one or more probability scores associated with the one or more heterogeneous datasets using the equations (1) and (2) based on the determination that the calculated Anderson Darling Test Statistic (A²) is greater than the critical value. The computer system 202 re-calculates the one or more first probability scores by increasing the dimension of the positional encoding embedding (d) in the formula given in equations (1) and (2). For example, the computer system 202 takes the value of d=5 and re-calculates the one or more first probability scores. The computer system 202 further repeats the operations from 306 to 320 based on the re-calculated one or more first probability scores until the determination that the calculated Anderson Darling Test Statistic (A²) is less than the critical value.

In an alternate embodiment of the disclosure, the computer system 202 further compares the critical value with the Cramer-von Mises test criterion (W²). In an embodiment of the disclosure, the computer system 202 determines that the calculated Cramér-von Mises test criterion (W²) is less than the critical value. In an embodiment of the disclosure, the computer system 202 further accepts the null hypothesis that the probability distribution fits the beta probability distribution graph based on the determination that the calculated Cramér-von Mises test criterion (W²) is less than the critical value. In an embodiment of the disclosure, the control of operations proceeds to 322 based on the determination that the calculated Cramér-von Mises test criterion (W²) is less than the critical value otherwise the control of operations moves back to 306.

In an embodiment of the disclosure, the control of operations moves back to 306 based on the determination that the calculated Cramer-von Mises test criterion (W²), is greater than the critical value. In an embodiment of the disclosure, the computer system further iteratively re-calculates the one or more probability scores associated with the one or more heterogeneous datasets using the equations (1) and (2) based on the determination that the calculated Cramér-von Mises test criterion (W²), is greater than the critical value. The computer system 202 re-calculates the one or more first probability scores by increasing the dimension of the positional encoding embedding (d) in the formula given in equations (1) and (2). For example, the computer system 202 takes the value of d=5 and re-calculates the one or more first probability scores. The computer system 202 further repeats the operations from 306 to 320 based on the re-calculated one or more first probability scores until the determination that the Cramér-von Mises test criterion (W²) is less than the critical value to increase the accuracy and the reliability of the data quality estimation (the determination of the quality score associated with the input dataset 212) and to identify the additional data quality issues such as data inconsistency, data redundancy, and data inaccuracies present in the input dataset 212.

At 322, a quality score determination operation is performed. In the quality score determination operation, the computer system 202 determines the quality score associated with the input dataset 212. In an embodiment of the disclosure, the computer system 202 determines the quality score associated with the input dataset 212 based on the validation of the beta probability density distribution graph associated with the input dataset 212. In an embodiment of the disclosure, the computer system 202 determines the quality score associated with the input dataset 212 based on the mean value of the probability distribution associated with the input dataset 212. The computer system 202 further calculates the expected value or the mean value of the probability distribution represented by the beta probability density distribution graph. In an embodiment of the disclosure, the computer system 202 further determines the expected value or the mean value associated with the beta probability density distribution graph as the quality score associated with the input dataset 212. In an embodiment of the disclosure, the computer system 202 utilizes the combination of the one or more first probability scores and the one or more second probability scores to determine the quality score that increases the accuracy and the reliability of the data quality estimation (the determination of the quality score associated with the input dataset 212) and helps in identifying the additional data quality issues such as data inconsistency, data redundancy, and data inaccuracies present in the input dataset 212.

At 324, it may be determined whether the quality score is greater than or equal to the threshold quality score. In an embodiment of the disclosure, the computer system 202 compares the quality score associated with the input dataset 212 with a threshold quality score. In an embodiment of the disclosure, the computer system 202 determines that the quality score associated with the input dataset 212 is greater than or equal to the threshold quality score. In an alternate embodiment of the disclosure, the computer system 202 determines that the quality score associated with the input dataset 212 is less than the threshold quality score. The threshold quality score is, for example, 0.5.

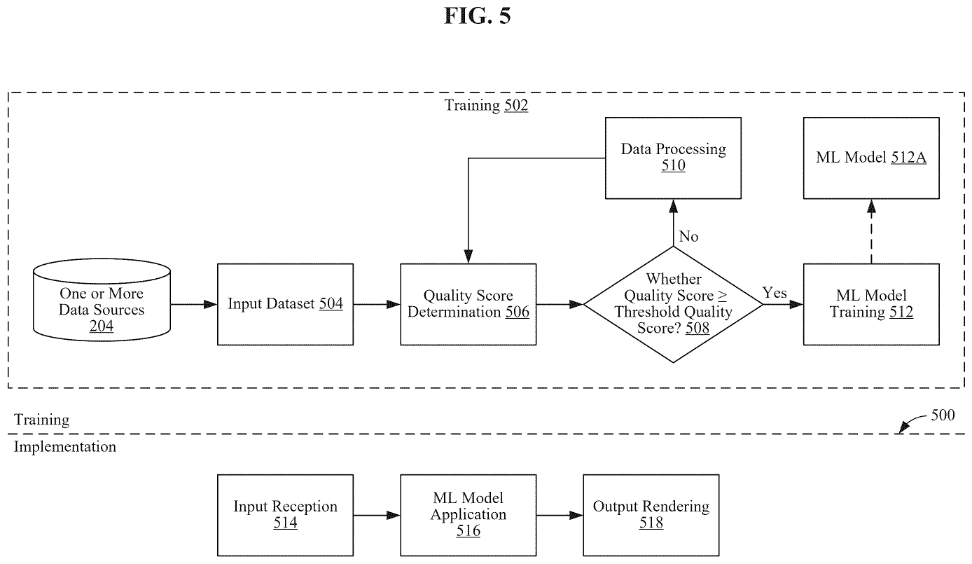

In an embodiment of the disclosure, the control of operations proceeds to 328 based on the determination that the quality score associated with the input dataset 212 is greater than or equal to the threshold quality score. In an embodiment of the disclosure, the computer system 202 ensures that the quality score associated with the input dataset 212 is greater than or equal to the threshold quality score before outputting the input dataset 212. The computer system 202 ensures that the quality score associated with the input dataset is greater than or equal to the threshold quality score before training the ML model. Details about the training of the ML model are provided in, for example, FIG. 5.

In an alternate embodiment of the disclosure, the control of operations proceeds to 326 based on the determination that the quality score associated with the input dataset 212 is less than the threshold quality score. In an embodiment of the disclosure, the computer system 202 applies one or more data processing techniques on the input dataset 212 to increase the quality score of the input dataset 212 if the quality score of the input dataset 212 is less than the threshold quality score.

At 326, data processing operation is performed. In the data processing operation, the computer system 202 applies one or more data processing techniques on the input dataset 212. In an embodiment of the disclosure, the computer system 202 applies the one or more data processing techniques on the input dataset 212 to increase the quality score associated with the input dataset 212 and to ensure that the quality score associated with the input dataset 212 is greater than or equal to the threshold quality score.

In an embodiment of the disclosure, the one or more data processing techniques include at least one of a data seeding technique or an imputation-based data cleaning technique. In an embodiment of the disclosure, the computer system 202 applies the data seeding technique on the input dataset 212 to increase the quality score associated with the input dataset 212. The data seeding is a technique used to enhance the quality of a dataset by systematically introducing or generating one or more new data items in the input dataset 212 based on the one or more existing data items of the input dataset 212.

In an embodiment of the disclosure, the computer system 202 utilizes the attention-based ML model 206 to generate one or more new data items based on the one or more existing data items. The computer system 202 applies the attention-based ML model 206 to the one or more existing data items. The attention-based ML model 206 identifies patterns and relationships in the one or more existing data items and generates the one or more new data items. Further, the computer system 202 merges the one or more new data items with the input dataset 212 to increase the quality score associated with the input dataset 212. In an embodiment of the disclosure, the computer system 202 iteratively repeats the operation of the application of data processing techniques until the quality score associated with the input dataset 212 is greater than or equal to the threshold quality score.

In an alternate embodiment of the disclosure, the computer system 202 applies the imputation-based cleaning technique on the input dataset 212 to increase the quality score associated with the input dataset 212. In an embodiment of the disclosure, the computer system 202 identifies one or more gaps or one or more null values within the input dataset 212. The one or more gaps are the discontinuities in the data where expected values are absent in the input dataset 212. The one or more null values are the one or more data items that have a null value (a zero or an empty string) at a specific data item. The computer system 202 identifies the data item occurring at the mean value index of the input dataset 212. Then, the computer system 202 replaces the one or more gaps and the one or more null values with the data item occurring at the mean value index.

In an alternate embodiment of the disclosure, the computer system 202 identifies the data item occurring at the median value index of the input dataset 212. Then, the computer system 202 replaces the one or more gaps and the one or more null values with the data item occurring at the median value index. In an alternate embodiment of the disclosure, the computer system 202 identifies the data item occurring at the mode value index of the input dataset 212. Then, the computer system 202 replaces the one or more gaps and the one or more null values with the data item occurring at the mode value index.

At 328, a result output operation is performed. In the result output operation, the computer system 202 outputs the determined quality score. In an embodiment of the disclosure, the computer system 202 outputs the determined quality score associated with the input dataset 212 based on the determination that the quality score associated with the input dataset 212 is greater than or equal to the threshold quality score. In an embodiment of the disclosure, the computer system 202 renders the determined quality score associated with the input dataset 212 on the user device 208. In an embodiment of the disclosure, the computer system 202 outputs the determined quality score based on the validation of the beta probability density distribution graph associated with the input dataset 212.

In an embodiment of the disclosure, the computer system 202 outputs the input dataset 212 based on the application of the one or more data processing techniques. In an embodiment of the disclosure, the computer system 202 outputs the input dataset 212 based on the determination that the quality score associated with the input dataset 212 is greater than or equal to the threshold quality score.

In an embodiment of the disclosure, the computer system 202 trains an ML model on the input dataset 212 based on the determination that the quality score associated with the input dataset 212 is greater than or equal to the threshold quality score. The ML model is different from the attention-based ML model 206 and may be trained to predict an output value based on an input value. Details about the ML model training operation are further provided, for example, in FIG. 5.

In an embodiment of the disclosure, the computer system 202 transforms the input dataset 212 into a lexicographical network graph based on the probability distribution associated with the input dataset 212. The lexicographical network graph corresponds to a force-directed network chart of the input dataset 212 and may be a visual representation of relationships between the one or more data items of the input dataset 212, arranged in a way that reflects a lexicographical order. The lexicographical network graphs include a set of nodes and a set of edges connecting the set of nodes.

In an embodiment of the disclosure, each node of the set of nodes of the lexicographical network graph represents each data item of the one or more data items of each heterogeneous dataset of the one or more heterogeneous datasets 214. Each edge of the set of edges of the lexicographical network graph represents the degree of relationship (each second probability score of the one or more second probability scores indicating the probability of co-occurrence of the one or more data items of the first heterogeneous dataset with the one or more data items of the second heterogeneous dataset) between the one or more data items of the respective heterogeneous dataset of the one or more heterogeneous datasets 214. Specifically, the thickness of each edge of the set of edges of the lexicographical network graph represents the degree of relationship in a relative manner. The thickness of each edge of the set of edges in a lexicographical network graph is defined as a visual representation of the strength or degree of relationship between the connected nodes.

In an embodiment of the disclosure, the computer system 202 determines the thickness of the set of edges connecting the set of nodes associated with the one or more data items based on the probability distribution associated with the input dataset 212. Further, the computer system 202 connects the first node of the set of nodes representing the first specific data item of the first heterogeneous dataset with a second node of the set of nodes representing a second specific data item of the second heterogeneous dataset via one edge. The thickness of the one edge between the first node and the second node represents the value inter-matrix probability of co-occurrence of the first specific data item of the first heterogeneous dataset with the second specific data item of the second heterogeneous dataset which is obtained from the probability distribution. In an embodiment of the disclosure, the computer system 202 further generates the lexicographical network graph based on similarly connecting the set of nodes representing the one or more data items of the respective heterogeneous dataset of the one or more heterogeneous datasets 214. The computer system 202 similarly connects the set of nodes via the set of edges. The computer system 202 similarly utilizes the thickness of the set of edges as a parameter for representing the value of inter-matrix probability (from the probability distribution) and generates the lexicographical network graph.

In an alternate embodiment of the disclosure, the computer system 202 assigns one or more weight values to each edge of the set of edges connecting the set of nodes within the lexicographical network graph based on the probability distribution. The one or more weight values may be indicative of the one or more second probability scores (the inter-matrix probabilities) associated with the one or more data items of the respective heterogeneous dataset of the one or more heterogeneous datasets 214. In an embodiment of the disclosure, the computer system 202 further generates the lexicographical network graph based on the assignment of the one or more weight values to the set of edges. In an embodiment of the disclosure, the computer system 202 further outputs the lexicographical network graph.

FIG. 4 is a diagram that illustrates an exemplary beta probability density distribution graph for data quality estimation using machine learning (ML) model, in accordance with an embodiment of the disclosure. FIG. 4 is explained in conjunction with elements from FIG. 1, FIG. 2, and FIG. 3. With reference to FIG. 4, there is shown a block diagram that illustrates an exemplary beta probability density distribution graph 400. The exemplary beta probability density distribution graph 400 includes a first axis 402, a second axis 404, and a probability distribution function (PDF) curve 406.

As discussed above, the computer system 202 calculates the value of estimated shape parameters α and β using the maximum likelihood estimation technique utilizing the equations (9) and (10). In an exemplary embodiment of the disclosure, the computer system 202 determines the value of shape parameters α=2 and β=8 that best fits the probability distribution. In an embodiment of the disclosure, the computer system 202 further determines the probability density distribution function (PDF) for the determined probability distribution associated with the input dataset 212 utilizing equation (4) as discussed above.

In an embodiment of the disclosure, the computer system 202 further generates the beta probability density distribution graph associated with the input dataset 212 based on the probability density distribution function (PDF) using the value of shape parameters α=2 and β=8. The first axis 402 of the beta probability density distribution graph 400 represents the values of the random variable X which represents the probability distribution associated with the input dataset 212. In an embodiment of the disclosure, the values on the first axis 402 represent the one or more second probability scores associated with the one or more data items of the respective heterogeneous dataset of the one or more heterogeneous datasets 214.

The second axis 404 of the beta probability density distribution graph 400 represents the probability density of the random variable X which represents the probability distribution associated with the input dataset 212. The probability density may be a fundamental concept in probability theory and statistics that describes how probabilities are distributed over a continuous random variable. Probability density does not represent probability directly but rather the density of probabilities for each point of the first axis 402.

The PDF curve 406 of the beta probability density distribution graph 400 corresponds to a curve of the probability distribution function (PDF) of the probability distribution described in equation (4). The PDF curve 406 indicates how the inter-matrix probabilities associated with the one or more data items of the respective heterogeneous datasets of the one or more heterogeneous datasets 214 are distributed across different values and serve as the foundation for various statistical methods and applications. With α=2 and β=8, the PDF curve 406 is left-skewed. The left-skewed feature of the PDF curve 406 indicates that the beta probability density distribution graph 400 has a higher concentration of values closer to 0 as it approaches 1. In an embodiment of the disclosure, the computer system 202 determines the quality score associated with the input dataset 212 based on the beta probability density distribution graph. The computer system 202 determines the quality score based on calculating the mean value of the probability distribution for which the beta probability density distribution graph is generated.

FIG. 5 is a diagram that illustrates training of a machine learning (ML) model using data quality estimation, in accordance with an embodiment of the disclosure. FIG. 5 is explained in conjunction with elements from FIG. 1, FIG. 2, FIG. 3 and FIG. 4. With reference to FIG. 5, there is a training portion above line 500 and an implementation portion below line 500. In the training portion above line 500, the computer system 202 ensures that the quality score associated with the input dataset is greater than the quality threshold for the training 502 of the ML model 512A.

The input dataset 504 includes the one or more heterogeneous datasets 214. Each heterogeneous dataset of the one or more heterogeneous datasets 214 includes the one or more data items. In an embodiment of the disclosure, the one or more heterogeneous datasets 214 include at least two of a categorical dataset, an ordinal dataset, a discrete dataset, or a continuous dataset. The categorical dataset corresponds to a dataset in which each data item of the dataset is distributed into one or more categories. The ordinal dataset is a dataset in which each data item of the dataset is distributed into one or more categories and has a meaningful order or ranking among the one or more categories. The discrete dataset is a dataset in which the numerical data items of the dataset include only whole numbers and not any fractional value or any decimal value. The continuous dataset is a dataset in which the numerical data items include whole numbers as well as fractional values and decimal values.

In an embodiment of the disclosure, the computer system 202 receives the input dataset 504 from the one or more data sources 204. In an embodiment, the one or more data sources 204 may correspond to one or more data warehouses associated with the one or more organizations working under different domains such as healthcare, finance, marketing, manufacturing, education, and the like. In such an implementation, the computer system 202 may be connected with the one or more data sources using application programming interfaces (APIs). The input dataset 504 is an exemplary embodiment of the input dataset 212.

In an exemplary embodiment of the disclosure, the computer system 202 receives the input dataset 504 that includes a first heterogeneous dataset (the ordinal dataset [91-100: A+, 81-90: A, 71-80: B+, 61-70: B, 51-60: C, 41-50: D, below 40: F]) that indicates a grade associated with a specific range of marks scored by a student. The input dataset 504 further includes a second heterogeneous dataset (the categorical dataset [1 Bedroom: 300$, 2 Bedroom: 600$, 3 Bedroom: 900$]) that indicates the monthly rent of a flat depending upon the number of bedrooms.

At 506 the quality score determination operation is performed. In the quality score determination operation, the computer system 202 determines the quality score associated with the input dataset. The computer system 202 applies the attention-based ML model 206 to the input dataset 504 and calculates the one or more first probability scores associated with the one or more data items of the respective heterogeneous dataset of the one or more heterogeneous datasets. The computer system 202 further determines the one or more encoding matrices associated with the respective heterogeneous dataset of the one or more heterogeneous datasets and applies the probabilistic operation on the one or more encoding matrices associated with each heterogeneous dataset of the one or more heterogeneous datasets. The computer system 202 determines the probability distribution associated with the input dataset 504 and calculates the mean value of the probability distribution associated with the input dataset 504. In an embodiment of the disclosure, the computer system 202 further determines the quality score associated with the input dataset 504 based on the mean value of the probability distribution associated with the input dataset 504. Details about the quality score determination operation are provided, for example, in FIG. 3.

At 508, the comparison operation is performed. In the comparison operation, the computer system 202 compares the quality score associated with the input dataset 504 with a threshold quality score. In an embodiment of the disclosure, the computer system 202 determines that the quality score associated with the input dataset 504 is greater than or equal to the threshold quality score. In an alternate embodiment of the disclosure, the computer system 202 determines that the quality score associated with the input dataset 504 is less than the threshold quality score. The threshold quality score is, for example, 0.5.

In an embodiment of the disclosure, the control of operations proceeds to 512 for training the ML model 512A based on the determination that the quality score associated with the input dataset 504 is greater than or equal to the threshold quality score. In an embodiment of the disclosure, the computer system 202 ensures that the quality score of the input dataset 504 is greater than the threshold quality score before training the ML model 512A. In an alternate embodiment of the disclosure, the control of operations proceeds to 510 based on the determination that the quality score associated with the input dataset is less than the threshold quality score. The control of operations proceeds to 510 to increase the quality score of the input dataset 504, which further ensures that the quality score of the input dataset is greater than the threshold quality score before training the ML model 512A.

In an exemplary embodiment of the disclosure, if the quality score associated with the input dataset 504 is 0.431 (lesser than the threshold quality score), then the control of operations proceeds to 510. The control of operations proceeds to 510 to increase the quality score of the input dataset 504, which further ensures that the quality score of the input dataset is greater than the threshold quality score before training the ML model 512A. In an alternate example embodiment of the disclosure, if the quality score associated with the input dataset 504 is 0.789, then the control of operations proceeds to 512. The control of operation proceeds to 512 for training the ML model 512A on the input dataset 504.

At 510, a data processing operation is performed. In the data processing operation, the computer system 202 applies one or more data processing techniques on the input dataset 504. In an embodiment of the disclosure, the computer system 202 applies the one or more data processing techniques on the input dataset 504 to increase the quality score associated with the input dataset 504 and to ensure that the quality score associated with the input dataset 504 is greater than or equal to the threshold quality score. In an embodiment of the disclosure, the one or more data processing techniques include at least one of the data seeding techniques or the imputation-based data cleaning technique. Details about the data processing operation are provided, for example, in FIG. 3.

At 512, an ML model training operation is performed. In the ML model training operation, the computer system 202 trains the ML model 512A on the input dataset 504 based on the determination that the quality score associated with the input dataset 504 is greater than or equal to the threshold quality score. The ML model 512A is different from the attention-based ML model 206. The ML model 512A is trained to predict an output value based on an input value.

In an exemplary embodiment of the disclosure, the computer system 202 trains the ML model 512A on the input dataset 504 which includes the first heterogenous dataset (the ordinal dataset [91-100: A+, 81-90: A, 71-80: B+, 61-70: B, 51-60: C, 41-50: D, below 40: F) that indicates a grade associated with specific ranges of marks scored by a student. The computer system 202 trains the ML model 512A to perform a classification task such as the classification of marks of students.

In an alternate exemplary embodiment of the disclosure, the computer system 202 trains the ML model 512A on the input dataset 504 that includes the second heterogeneous dataset (the categorical dataset [1 Bedroom: 300$, 2 Bedroom: 600$, 3 Bedroom: 900$] that indicates monthly rent of a flat depending upon the number of bedrooms. The computer system 202 trains the ML model 512A to perform a regression task such as predicting the monthly rent of a flat based on the number of bedrooms.

The ML model 512A corresponds to one of a neural network-based regression model or a neural network-based classifier. The neural network is a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer are coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on a training dataset. Each node of the neural network corresponds to a mathematical function (e.g., a sigmoid function or a rectified linear unit) with a set of parameters, tunable during training of the neural network. The set of parameters includes, for example, a weight parameter, a regularization parameter, and the like. Each node uses the mathematical function to compute an output based on one or more inputs from nodes in other layer(s) (e.g., previous layer(s)) of the neural network. All or some of the nodes of the neural network correspond to the same or a different mathematical function.

In the training of the ML model 512A, one or more parameters of each node of the ML model 512A may be updated based on whether an output of the final layer for a given input (from the training dataset) matches a correct result based on a loss function for the ML model 512A. The above process may be repeated for the same or a different input until a minima of loss function may be achieved, and a training error may be minimized.

The neural network includes electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Accordingly, in some embodiments, the ML model 512A is a separate entity in the computer system 202, without deviation from the scope of the disclosure.

In the implementation portion below line 500, an input reception operation 514 is performed. In the input reception operation, the computer system 202 receives the input. In an embodiment of the disclosure, the computer system 202 receives the input from the user device 208. In an exemplary embodiment of the disclosure, the computer system 202 receives the marks of a specific child in 3 subjects as [83, 72, 65]. In an alternate exemplary embodiment of the disclosure, the computer system 202 receives the number of bedrooms in a specific flat for predicting the monthly rent of the specific flat as [4 Bedrooms].

At 516, an ML model application operation is performed. In the ML model application operation, the computer system 202 applies the ML model 512A to the input received from the user device 208. The ML model 512A analyzes the input based on its training data (the input dataset 504) and predicts the output. In an exemplary embodiment of the disclosure, the ML model 512A classifies the grades of the specific student [83, 72, 65] in the specific grades based on the input dataset 504. The ML model 512A predicts the output as a classified dataset of marks of the specific student in the 3 subjects [83: A, 72: B+, 65: B]. The computer system 202 determines the output based on the application of the ML model 512A to the input.

In an alternate exemplary embodiment of the disclosure, the ML model 512A determines the monthly rent of the specific flat as 1200$ based on the training dataset (the input dataset 504 that includes the second heterogeneous dataset (the categorical dataset [1 Bedroom: 300$, 2 Bedroom: 600$, 3 Bedroom: 900$] that indicates monthly rent of a flat depending upon the number of bedrooms. The computer system 202 then determines the output based on the application of the ML model 512A to the input.

At 518, an output rendering operation is performed. In the output rendering operation, the computer system 202 renders the determined output. In an embodiment of the disclosure, the computer system 202 renders the determined output on the user device 208. In an exemplary embodiment of the disclosure, the computer system 202 renders the classified dataset of marks of the specific student [83: A, 72: B+, 65: B] on the user device 208. In an alternate exemplary embodiment of the disclosure, the computer system 202 renders the monthly rent of the specific flat 1200$ on the user device 208.

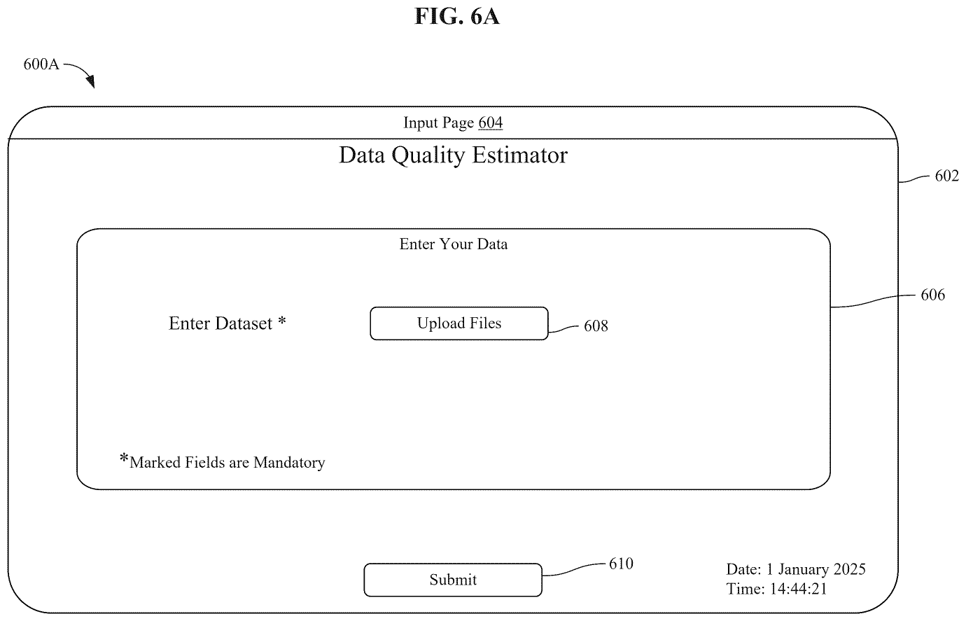

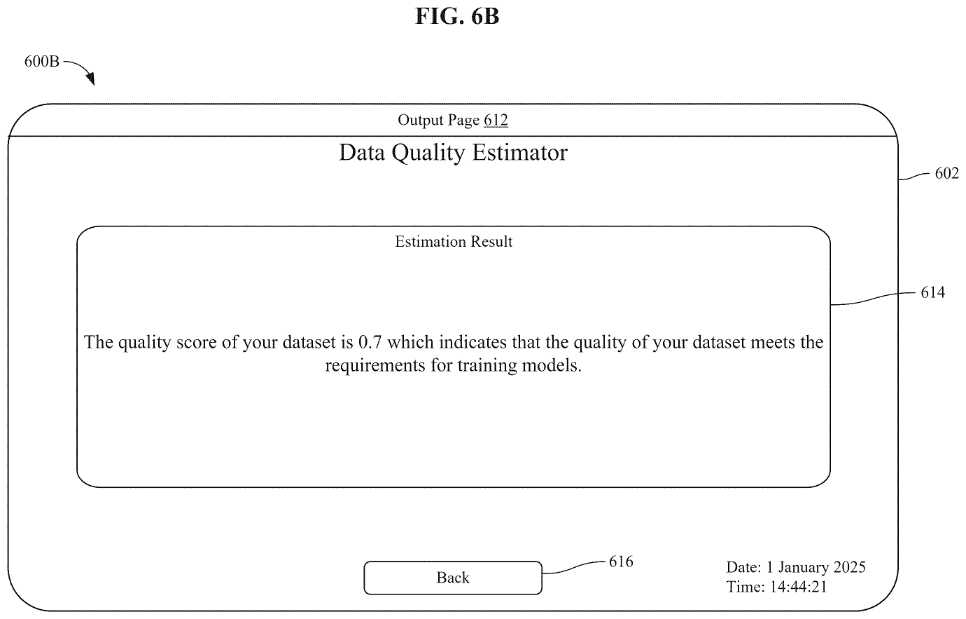

FIG. 6A is a diagram that illustrates an exemplary first user interface for data quality estimation using machine learning (ML) models, in accordance with an embodiment of the disclosure. FIG. 6A is explained in conjunction with elements from FIG. 1, FIG. 2, FIG. 3, FIG. 4, and FIG. 5. With reference to FIG. 6A, there is shown an exemplary diagram 600A that includes a user device 602 and an exemplary input page 604. The exemplary input page 604 includes a first user interface (UI) element 606, a second UI element 608, and a third UI element 610. The user device 602 is an exemplary embodiment of the user device 208 of FIG. 2.

With reference to FIG. 6A, the computer system 202 receives the input dataset 212 that includes the one or more heterogeneous datasets 214 from the user device 602. The user device 602 includes a display unit (a user interface) that renders the exemplary input page 604 to the user 216. The computer system 202 renders the exemplary input page 604 on the user interface (UI) of the user device 602. The exemplary input page 604 corresponds to a web page or online form that is designed to collect information from entities who wish to estimate the quality score of their datasets. In an embodiment of the disclosure, the exemplary input page 604 is used to obtain the input dataset 212 from the entities for estimating the quality score of the input dataset 212.

The first UI element 606 corresponds to a textbox that includes a message for user 216, for example, “Enter Your Data”. The first UI element 606 further includes the second UI element 608. The second UI element 608 corresponds to a button and is labeled as “Upload Files”. Upon selecting the second UI element 608, the user is asked to provide the input dataset 212 in the form of a file, for example, a comma-separated values (CSV) file, an Excel file, or the like. Then, the computer system 202 obtains the input dataset upon providing the file. In an exemplary embodiment of the disclosure, the computer system 202 obtains the CSV file that includes the first heterogeneous dataset [“AssetID234”, “Colorado”, “ABC”, “XX234”] and the CSV file that includes the second heterogeneous dataset [A, B, C, D].

The third UI element 610 corresponds to a button and is labeled as “Submit”. Upon selecting the third UI element 610, the computer system 202 receives the input dataset 212 and further initiates the data quality estimation. For example, the computer system 202 performs the quality score determination operation 506 upon selecting the third UI element 610. Details about the quality score determination operation are provided, for example, in FIG. 5.

FIG. 6B is a diagram that illustrates an exemplary second user interface for data quality estimation using machine learning (ML) models, in accordance with an embodiment of the disclosure. FIG. 6B is explained in conjunction with elements from FIG. 1, FIG. 2, FIG. 3, FIG. 4, FIG. 5, and FIG. 6A. With reference to FIG. 6B, there is shown an exemplary diagram 600B that includes the user device 602 and an exemplary output page 612. The exemplary output page 612 includes a fourth UI element 614 and a fifth UI element 616. The user device 602 is an exemplary embodiment of the user device 208 of FIG. 2.

With reference to FIG. 6B, the computer system 202 renders the exemplary output page 612 on the display unit (or the user interface) of the user device 602 based on the determination of the quality score associated with the input dataset 212. The computer system 202 renders the determined quality score associated with the input dataset 212 on the exemplary output page 612.

The fourth UI element 614 corresponds to a textbox that includes a message that indicates the quality score associated with the input dataset. In an exemplary embodiment of the disclosure, the message may be, for example, “Estimation Result: The quality score of your dataset is 0.7 which indicates that the quality of your dataset meets the requirements for training models.”. The fifth UI element 616 corresponds to a button and is labeled as “Back”. In an embodiment of the disclosure, the computer system 202 renders the exemplary input page 604 on the user interface of the user device 602 upon selecting the fifth UI element 616.

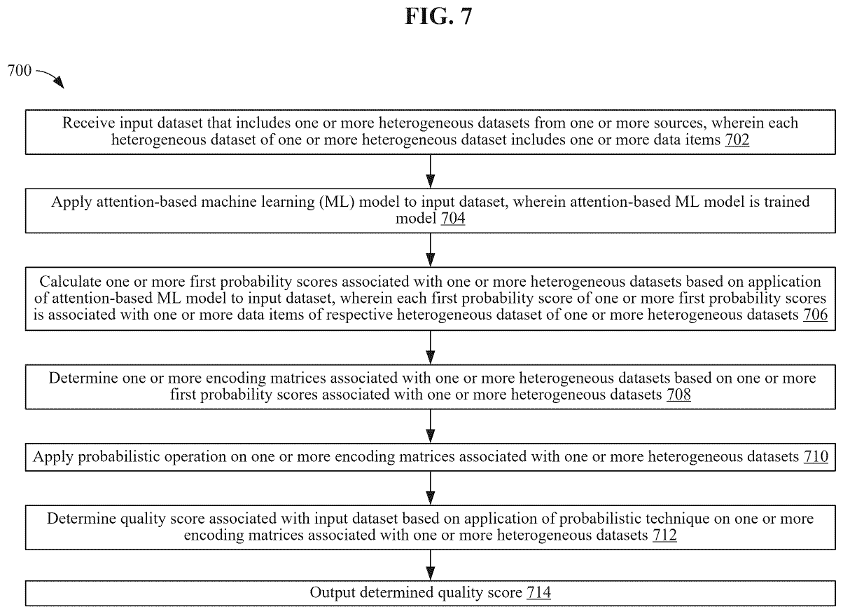

FIG. 7 is a diagram that illustrates a flowchart of an exemplary method for data quality estimation using machine learning (ML) model, in accordance with an embodiment of the disclosure. FIG. 7 is explained in conjunction with elements from FIG. 1, FIG. 2, FIG. 3, FIG. 4, FIG. 5, FIG. 6A and FIG. 6B. With reference to FIG. 7, there is shown a flowchart 700. The operations of the exemplary method may be executed by any computing system, for example, by the computer 102 of FIG. 1 or the computer system 202 of FIG. 2. The operations of the flowchart 700 may start at 702.

At 702, the input dataset 212 including the one or more heterogeneous datasets 214 is received from the one or more data sources 204. Each heterogeneous dataset of the one or more heterogeneous datasets 214 includes the one or more data items. In an embodiment of the disclosure, the computer system 202 receives the input dataset 212 including the one or more heterogeneous datasets 214 from the one or more data sources 204. Each heterogeneous dataset of the one or more heterogeneous datasets 214 includes the one or more data items. Details about the input dataset reception operation are provided, for example, in FIG. 3.

At 704, the attention-based machine learning (ML) model 206 is applied to the input dataset 212. In an embodiment of the disclosure, the computer system 202 applies the attention-based ML model 206 to the input dataset 212. Details about the attention-based ML model application operation are provided, for example, in FIG. 3.

At 706, the one or more first probability scores associated with the one or more heterogeneous datasets 214 are calculated based on the application of the attention-based ML model 206 to the input dataset 212. Each first probability score is associated with the one or more data items of the respective heterogeneous dataset of the one or more heterogeneous datasets 214. In an embodiment of the disclosure, the computer system 202 calculates the one or more first probability scores associated with the one or more heterogeneous datasets 214 based on the application of the attention-based ML model 206 to the input dataset 212. Each first probability score is associated with the one or more data items of the respective heterogeneous dataset of the one or more heterogeneous datasets 214. Details about the first probability score calculation operation are provided, for example, in FIG. 3.

At 708, one or more encoding matrices associated with the one or more heterogeneous datasets 214 are determined based on the one or more first probability scores associated with the one or more heterogeneous datasets 214. In an embodiment of the disclosure, the computer system 202 determines the one or more encoding matrices associated with the one or more heterogeneous datasets 214 based on the one or more first probability scores associated with the one or more heterogeneous datasets 214. Details about the encoding matrix determination operation are provided, for example, in FIG. 3.

At 710, the probabilistic operation is applied to the one or more encoding matrices associated with the one or more heterogeneous datasets 214. In an embodiment of the disclosure, the computer system 202 applies the probabilistic operation on the one or more encoding matrices associated with the one or more heterogeneous datasets 214. Details about the probabilistic operation application are provided, for example, in FIG. 1 and FIG. 3.

At 712, the quality score associated with the input dataset 212 is determined based on the application of the probabilistic operation on the one or more encoding matrices associated with the one or more heterogeneous datasets 214. In an embodiment of the disclosure, the computer system 202 determines the quality score associated with the input dataset 212 based on the application of the probabilistic operation on the one or more encoding matrices associated with the one or more heterogeneous datasets 214. Details about the quality score determination operation are provided, for example, in FIG. 3.

At 714, the determined quality score is outputted. In an embodiment of the disclosure, the computer system 202 outputs the determined quality score. Details about the quality score output operation are provided, for example, in FIG. 3.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a computer, an input dataset comprising one or more heterogeneous datasets from one or more data sources, wherein each heterogeneous dataset of the one or more heterogeneous datasets comprises one or more data items;
applying, by the computer, an attention-based machine learning (ML) model to the input dataset;
calculating, by the computer, one or more first probability scores associated with the one or more heterogeneous datasets based on the application of the attention-based ML model to the input dataset, wherein each first probability score of the one or more first probability scores is associated with the one or more data items of a respective heterogeneous dataset of the one or more heterogeneous datasets;
determining, by the computer, one or more encoding matrices associated with the one or more heterogeneous datasets based on the one or more first probability scores associated with the one or more heterogeneous datasets;
applying, by the computer, a probabilistic operation on the one or more encoding matrices associated with the one or more heterogeneous datasets;
determining, by the computer, a quality score associated with the input dataset based on the application of the probabilistic operation on the one or more encoding matrices associated with the one or more heterogeneous datasets; and
outputting, by the computer, the determined quality score.

2. The computer-implemented method of claim 1, wherein the one or more heterogeneous datasets comprise at least two of a categorical dataset, an ordinal dataset, a discrete dataset, or a continuous dataset.

3. The computer-implemented method of claim 1, wherein each first probability score of the one or more first probability scores associated with the one or more data items of the respective heterogeneous dataset corresponds to a positional encoding embedding of the one or more data items of the respective heterogeneous dataset of the one or more heterogeneous datasets.

4. The computer-implemented method of claim 1, further comprising:
calculating, by the computer, one or more second probability scores associated with the one or more heterogeneous datasets based on the one or more first probability scores, wherein:
each second probability score of the one or more second probability scores is associated with the one or more data items of the respective heterogeneous dataset of the one or more heterogeneous datasets, and
each second probability score of the one or more second probability scores is calculated based on a respective first probability score of the one or more first probability scores;
determining, by the computer, one or more probabilistic data vectors associated with the one or more heterogeneous datasets based on the one or more second probability scores associated with the one or more heterogeneous datasets;
determining, by the computer, a probability distribution associated with the input dataset based on the one or more probabilistic data vectors; and
determining, by the computer, the quality score associated with the input dataset based on the probability distribution.

5. The computer-implemented method of claim 4, further comprising:
transforming, by the computer, the input dataset into a lexicographical network graph based on the probability distribution associated with the input dataset, wherein the lexicographical network graph corresponds to a force-directed network chart of the input dataset; and
outputting, by the computer, the lexicographical network graph.

6. The computer-implemented method of claim 4, wherein the one or more second probability scores correspond to a log-likelihood score of the one or more data items of a first heterogeneous dataset of the one or more heterogeneous datasets co-occurring with the one or more data items of a second heterogeneous dataset of the one or more heterogeneous datasets.

7. The computer-implemented method of claim 4, wherein the quality score associated with the input dataset corresponds to a mean value of the probability distribution associated with the input dataset.

8. The computer-implemented method of claim 4, further comprising:
generating, by the computer, a beta probability density distribution graph associated with the input dataset based on the probability distribution associated with the input dataset; and
determining, by the computer, the quality score associated with the input dataset based on the beta probability density distribution graph.

9. The computer-implemented method of claim 8, further comprising:
applying, by the computer, a statistical test on the beta probability density distribution graph associated with the input dataset;
validating, by the computer, the beta probability density distribution graph associated with the input dataset based on the application of the statistical test on the beta probability density distribution graph; and
outputting, by the computer, the determined quality score based on the validation.

10. The computer-implemented method of claim 9, wherein the statistical test corresponds to one of an Anderson-Darling test or a Cramér-von Mises test.

11. The computer-implemented method of claim 1, further comprising:
determining, by the computer, the quality score associated with the input dataset is greater than or equal to a threshold quality score; and
outputting, by the computer, the input dataset based on the determination that the quality score associated with the input dataset is greater than or equal to the threshold quality score.

12. The computer-implemented method of claim 11, further comprising training, by the computer, a machine learning (ML) model on the input dataset based on the determination that the quality score associated with the input dataset is greater than or equal to the threshold quality score, wherein the ML model is trained to predict an output value based on an input value, and wherein the ML model is different from the attention-based ML model.

13. The computer-implemented method of claim 1, further comprising:
determining, by the computer, the quality score associated with the input dataset is less than a threshold quality score;
applying, by the computer, one or more data processing techniques on the input dataset based on the determination that the quality score associated with the input dataset is less than the threshold quality score; and
outputting, by the computer, the input dataset based on the application of the one or more data processing techniques on the input dataset.

14. The computer-implemented method of claim 13, wherein the one or more data processing techniques comprise at least one of a data seeding technique or an imputation-based data cleaning technique.

15. A computer system, comprising:
a processor set;
one or more computer-readable storage media; and
program instructions stored on the one or more computer-readable storage media, the program instructions executable by the processor set to cause the processor set to:
receive an input dataset that comprises one or more heterogeneous datasets from one or more data sources, wherein each heterogeneous dataset of the one or more heterogeneous datasets comprises one or more data items;
apply an attention-based machine learning (ML) model to the input dataset;
calculate one or more first probability scores associated with the one or more heterogeneous datasets based on the application of the attention-based ML model to the input dataset, wherein each first probability score of the one or more first probability scores is associated with the one or more data items of a respective heterogeneous dataset of the one or more heterogeneous datasets;
determine one or more encoding matrices associated with the one or more heterogeneous datasets based on the one or more first probability scores associated with the one or more heterogeneous datasets;
apply a probabilistic operation on the one or more encoding matrices associated with the one or more heterogeneous datasets;
determine a quality score associated with the input dataset based on the application of the probabilistic operation on the one or more encoding matrices associated with the one or more heterogeneous datasets; and
output the determined quality score.

16. The computer system of claim 15, wherein the program instructions further cause the processor set to:
calculate one or more second probability scores associated with the one or more heterogeneous datasets based on the one or more first probability scores, wherein:
each second probability score of the one or more second probability scores is associated with the one or more data items of the respective heterogeneous dataset of the one or more heterogeneous datasets, and
each second probability score of the one or more second probability scores is calculated based on a respective first probability score of the one or more first probability scores;
determine one or more probabilistic data vectors associated with the one or more heterogeneous datasets based on the one or more second probability scores associated with the one or more heterogeneous datasets;
determine a probability distribution associated with the input dataset based on the one or more probabilistic data vectors; and
determine the quality score associated with the input dataset based on the probability distribution.

17. The computer system of claim 16, wherein the program instructions further cause the processor set to:
generate a beta probability density distribution graph associated with the input dataset based on the probability distribution associated with the input dataset;
apply a statistical test on the beta probability density distribution graph associated with the input dataset;
validate the beta probability density distribution graph associated with the input dataset based on the application of the statistical test on the beta probability density distribution graph; and
output the determined quality score based on the validation.

18. The computer system of claim 15, wherein the program instructions further cause the processor set to:
determine the quality score associated with the input dataset is greater than or equal to a threshold quality score; and
output the input dataset based on the determination that the quality score associated with the input dataset is greater than or equal to the threshold quality score.

19. The computer system of claim 15, wherein the program instructions further cause the processor set to:
determine the quality score associated with the input dataset is less than a threshold quality score;
apply one or more data processing techniques on the input dataset based on the determination that the quality score associated with the input dataset is less than the threshold quality score, wherein the one or more data processing techniques comprise at least one of a data seeding technique or an imputation-based data cleaning technique; and
output the input dataset based on the application of the one or more data processing techniques on the input dataset.

20. A computer-program product for determination of a quality score associated with an input dataset, the computer-program product comprising:
one or more computer-readable storage media; and
program instructions stored on the one or more computer-readable storage media to perform operations comprising:
receiving the input dataset that comprises one or more heterogeneous datasets from one or more data sources, wherein each heterogeneous dataset of the one or more heterogeneous datasets comprises one or more data items;
applying an attention-based machine learning (ML) model to the input dataset;
calculating one or more first probability scores associated with the one or more heterogeneous datasets based on the application of the attention-based ML model to the input dataset, wherein each first probability score of the one or more first probability scores is associated with the one or more data items of a respective heterogeneous dataset of the one or more heterogeneous datasets;
determining one or more encoding matrices associated with the one or more heterogeneous datasets based on the one or more first probability scores associated with the one or more heterogeneous datasets;
applying a probabilistic operation on the one or more encoding matrices associated with the one or more heterogeneous datasets;
determining the quality score associated with the input dataset based on the application of the probabilistic operation on the one or more encoding matrices associated with the one or more heterogeneous datasets; and
outputting the determined quality score.
